(19) United States
(12) Patent Application Publication
(10) Pub. No.: US 2005/0144065 A1
(43) Pub. Date: Jun. 30, 2005

(54) Keyword advertisement management with coordinated bidding among advertisers

(75) Inventors: Hermann Calabria, Los Altos, CA (US); Francine R. Chen, Menlo Park, CA (US); Ayman O. Farahat, San Francisco, CA (US); Daniel H. Greene, Sunnyvale, CA (US)

Correspondence Address: Mark S. Svat;FAY, SHARPE, FAGAN, MINNICH & McKEE, LLP, SEVENTH FLOOR, 1100 SUPERIOR AVENUE, CLEVELAND, OH, 44114-2579, US

(73) Assignee: PALO ALTO RESEARCH CENTER INCORPORATED

(21) Appl. No.: 10/741,354

(22) Filed: Dec. 19, 2003

(51) Int. Cl. G06F 17/60

(52) U.S. Cl. 705/14; 705/37

(57) ABSTRACT

A method of coordinating one or more bids for one or more groups of advertisers for placement of at least one advertisement in association with a search results list is provided. The search results list is generated in response to a search query. The method includes: a) collecting information from at least two advertisers in the advertiser group and b) devising a joint strategy for the advertiser group for bidding in the keyword auction. In another embodiment, a method of generating a bid for a first advertiser for placement of a first advertisement in association with a search results list is provided. In another embodiment, an apparatus for generating the bid for the first advertiser is provided. Is still another embodiment, a method of coordinating bids from a first advertiser and a second advertiser for placement of at least one advertisement in association with a first search results list is provided.

### BACKGROUND

The present exemplary embodiment relates to keyword advertising associated with or found within a regular search results list generated, for example, by an Internet search engine in response to a keyword query submitted by a user. It finds particular application in conjunction with at least partially automating generation of bids for positions of keyword advertisements in a competitive bidding environment, wherein the keyword advertisement positions are associated with or part of the regular search results list, and will be described with particular reference thereto. However, it is to be appreciated that the present exemplary embodiment is also amenable to other like applications.

An increasingly popular way of delivering Internet advertisements is to tie the advertisement to search query results. In order to target advertising accurately, advertisers or vendors pay to have their advertisements presented in response to certain kinds of queries—that is, their advertisements are presented when particular keyword combinations are supplied by the user of the search engine.

For example, when a user searches for “deck plans,” using a search engine such as Google or AltaVista, in addition to the usual query results, the user will also be shown a number of sponsored results. These will be paid advertisements for businesses, generally offering related goods and/or services. In this example, the advertisements may therefore be directed to such things as deck plans, lumber, wood sealers, or even design automation software. Of course, the advertisements may be directed to seemingly less related subject matter. While the presentation varies somewhat between search engines, these sponsored results are usually shown a few lines above, or on the right hand margin of the regular results. Although, the sponsored results may also be placed anywhere in conjunction with the regular results.

Keyword advertising is growing as other types of web advertising are generally declining. It is believed there are at least several features that contribute to its success. First, sponsored results are piggybacked on regular results, so they are delivered in connection with a valuable, seemingly objective, service to the user. By contrast, search engines that are built primarily on sponsored results have not been as popular. Second, the precision of the targeting of the advertising means the user is more likely to find the advertisements useful, and consequently will perceive the advertisements as more of a part of the service than as an unwanted intrusion. Unlike banners and pop-up advertisements, which are routinely ignored or dismissed, users appear more likely to click through these sponsored results (i.e., keyword advertisements). Third, the targeting is based entirely on the current query, and not on demographic data developed over longer periods of time. This kind of targeting is timelier and more palatable to users with privacy concerns. Fourth, these advertisements reach users when they are searching, and therefore when they are more open to visiting new web sites.

Companies, such as Google of Mountain View, Calif. (which offers a search engine) and Overture of Pasadena, Calif. (which aggregates advertising for search engines as well as offering its own search engine), use an auction mechanism combined with a pay-per-click (PPC) pricing strategy to sell advertising. This model is appealing in its simplicity. Advertisers bid in auctions for placement of their advertisements in connection with particular keywords or keyword combinations. The amount they bid (i.e., cost-per-click (CPC)) is the amount that they are willing to pay for a click-through to their link. For example, in one PPC pricing strategy, if company A bids $1.10 for “deck plans” then its advertisement will be placed above a company bidding $0.95. Only a selected number of bidders' advertisements will be shown. The simplicity of the model makes it easy for an advertiser to understand why an advertisement is shown, and what bid is necessary to have an advertisement shown. It also means that advertisers are charged only for positive responses.

Both Google and Overture offer tools to help users identify additional keywords based on an initial set of keywords. The Overture model supplies keywords that actually contain the keyword (e.g. for bicycle one can get road bicycle, Colonago bicycle, etc.). Google, on the other hand, performs some kind of topic selection, which they claim is based on billions of searches.

Both Google and Overture offer tools to help users manage their bids. Google uses click-through rate and PPC to estimate an expected rate of return which is then used to dynamically rank the advertisements. Overture uses the PPC pricing strategy to rank advertisements, but monitors the click-through rate for significantly under performing advertisements.

Because Google dynamically ranks the advertisements based on click-through and PPC, advertisers cannot control their exact advertisement position with a fixed PPC. To insure a top position, the advertiser must be willing to pay a different price that is determined by their own click through rate as well as the competitors click-though rates and PPC. Overture uses a fixed price model, which insures fixed position for fixed price.

If a set of keywords that have not been selected by any of the advertisers is issued as a search term, Google will attempt to find the best matching selected set of keywords and display its associated advertisements. For example, let's say a user searches on “engagement ring diamond solitaire.” However, there are no advertisers bidding on this search term. The expanded matching feature will then match (based on term, title and description) selected listings from advertisers that have bid on search terms like “solitaire engagement ring” and “solitaire diamond ring.”

A number of third parties provide services to Overture customers to identify and select keywords and track and rank bids. For example, BidRank, Dynamic Keyword Bid Maximizer, Epic Sky, GoToast, PPC BidTracker, PPC Pro, Send Traffic, and Sure Hits. There are a small number of pay-per-bid systems. For example, Kanoodle is a traditional pay-per-bid system like Overture. Other examples, include Sprinks and FindWhat.

Sprinks' ContentSprinks™ listings rely on context, as opposed to one-to-one matching with a keyword. The user chooses topics, rather than keywords. The web site says “Since context is more important than an exact match, you can put your offer for golf balls in front of customers who are researching and buying golf clubs, and your listing will still be approved, even though it's not an exact match.” This is a pay-per-bid model, like Overture, and has been used by About.com, IVillage.com and Forbes.com. KeywordSprinks™ is a traditional pay-per-bid model for keywords and phrases system.

FindWhat has a BidOptimizer that shows the bids of the top five positions so that a user can set their bid price for a keyword to be at a specific position. It does not continually adjust bids like E-Bay and Overture.

In addition, there is a system called Wordtracker for helping users to select keywords. The Wordtracker system at <www.wordtracker.com> provides a set of tools to help users to identify keywords for better placement of advertisements and web pages in search engines, both regular and pay-per-bid. Wordtracker provides related words with occurrence information, misspelled word suggestions based on the number of occurrences of the misspelled words, and tools for keeping track of possible keyword/key phrase candidates. The related words are more than variants. On the web site, an example of related keywords for “golf” includes pga, Ipga, golf courses, tiger woods, golf clubs, sports, jack nicklaus, and titleist, as well as phrases that include the term “golf,” such as golf clubs, golf courses, golf equipment, used golf clubs, golf tips, golf games, and vw.golf. Wordtracker displays the bid prices for a keyword on selected pay-per-bid search engines. It also displays the number of occurrences of search terms by search engine so the keywords can be tuned to each search engine.

This is a very effective business model, but it does not automate certain aspects of the advertiser's decision-making, bidding, and placement of advertisements. Currently, an advertiser must participate in every auction of relevant keywords. In the example above, a company offering design automation software for home improvement may want its advertisements to be placed with a variety of keywords corresponding to common home improvement projects. These keywords vary in their relevance to the company's business, in their “yield” of productive click-through visits to the company's web site, and their cost to the company (based on competition in the auctions). The multiplicity of keyword combinations and the multiplicity of considerations for each keyword combination create a number of opportunities for automation support mechanisms for advertisement placement decision making.

In the process of bidding in keyword auctions, advertisers may compete in ways that are mutually detrimental. There may be better joint strategies that are less costly, or involve alternative keywords, but the individual bidders do not easily discover these joint strategies. Even when the individual bidders know good joint strategies, the individual bidders may not have a strong incentive to pursue these strategies without some assurance of cooperation.

Several published U.S. patent applications disclose concepts related to bidding for a position of a keyword advertisement in a search results list. For example, U.S. Patent Application Pub. No. U.S. 2003/0055729 A1, incorporated herein by reference, discloses a method and system for allocating display space on a web page. In one embodiment, the display space system receives multiple bids each indicating a bid amount and an advertisement. When a request is received to provide a web page that includes the display space, the display space system selects a bid based in part on the bid amount. The display space system then adds the advertisement of the selected bid to the web page. The bid may also include various criteria that specify the web pages on which the advertisement may be placed, the users to whom the advertisement may be presented, and the time when the advertisement may be placed. The bid amount may be a based on an established currency or based on advertising points. The display space system may award advertising points for various activities that users perform. The activities for which advertising points may be awarded may include the listing of an item to be auctioned, the bidding on an item being auctioned, the purchasing of an item at an auction, or the purchasing of an item at a fixed price. The display space system tracks the advertising points that have been allocated to each user. When an advertisement is placed on a web page on behalf of the user, the display space system reduces the number of advertising points allocated to that user. The display space system may also provide an auto bidding mechanism that places bids for display space on behalf of the user.

U.S. Patent Application Pub. No. U.S. 2003/0055816 A1, incorporated herein by reference, discloses a pay-for-placement search system that makes search term recommendations to advertisers managing their accounts in one or more of two ways. A first technique involves looking for good search terms directly on an advertiser's web site. A second technique involves comparing an advertiser to other, similar advertisers and recommending the search terms the other advertisers have chosen. The first technique is called spidering and the second technique is called collaborative filtering. In the preferred embodiment, the output of the spidering step is used as input to the collaborative filtering step. The final output of search terms from both steps is then interleaved in a natural way.

U.S. PatentApplication Pub. No. U.S. 2003/0105677 A1, incorporated herein by reference, discloses an automated web ranking system which enables advertisers to dynamically adjust pay-per-click bids to control advertising costs. The system tracks search terms which are used to market an advertiser's product or services in on line marketing media (“OMM”). The system determines the search term's effectiveness by collecting and analyzing data relating to the number of impressions, the number of clicks, and the number of resulting sales generated by a search term at a given time period. Based on the data collected and parameters which the advertiser provides relating to the advertiser's economic factors, the system calculates a maximum acceptable bid for each search term. The system monitors the web for competitor's bids on an advertiser's search term and places bids which fall below the maximum acceptable bid.

If the process of selecting and bidding for keyword combinations for an advertiser was automated or more automated, it likely that less guidance would be required from the advertiser and that advertisements would be placed on more effective keywords. It is also likely that such automation would help maximize return on advertising investment (ROAI), increase the number sponsored keywords, and maximize click-through rates for keyword advertisements.

The present exemplary embodiment contemplates a new and improved keyword searching environment with new and improved automation, including an improved keyword search engine and an improved keyword advertising management system, which overcomes the above-referenced problems and others.

### BRIEF DESCRIPTION

In accordance with one aspect of the present exemplary embodiment, a method of coordinating one or more bids for one or more groups of advertisers for placement of at least one advertisement in association with a first search results list is provided. The first search results list is generated in response to a first search query. The method includes: a) collecting information from at least two advertisers in the advertiser group and b) devising a joint strategy for the advertiser group for bidding in the keyword auction.

In accordance with one aspect of the present exemplary embodiment, a method of generating a bid for a first advertiser for placement of a first advertisement in association with a search results list, wherein the search results list is generated in response to a search query, is provided. The method includes: a) selecting at least one keyword, wherein the search query is associated with the at least one keyword, b) associating the at least one keyword with the bid, c) determining a first amount of the bid for placement of the first advertisement in association with the search results list generated in response to the search query associated with the at least one keyword, and d) exchanging information with a second advertiser bidding on placement of a second advertisement in association with the search results list generated in response to the search query associated with the at least one keyword, wherein the information exchanged at least includes the first amount.

In accordance with another aspect of the present exemplary embodiment, an apparatus for generating a bid for a first advertiser for placement of a first advertisement in association with a search results list, wherein the search results list is generated in response to a search query, is provided. The apparatus includes: an advertisement selection system for selecting the first advertisement to be associated with the bid, a keyword selection system in communication with the advertisement selection system for selecting a plurality of keywords associated with the advertisement, a keyword/bid association system in communication with at least one of the advertisement selection system and keyword selection system for associating one or more of the plurality of keywords with the bid, wherein the search query is associated with the one or more keywords, a bid determination system in communication with at least one of the advertisement selection system, keyword selection system, and keyword/bid association system for determining a first amount of the bid for placement of the selected advertisement in association with the search results list generated in response to the search query associated with the one or more keywords, and a group optimization logic system in communication with the bid determination system for exchanging information with a second advertiser bidding on placement of a second advertisement in association with the search results list generated in response to the search query associated with the at least one keyword, wherein the information exchanged at least includes the first amount.

In accordance with still another aspect of the present exemplary embodiment, a method of coordinating bids from a first advertiser and a second advertiser for placement of at least one advertisement in association with a first search results list, wherein the first search results list is generated in response to a first search query, is provided. The method includes: a) receiving at least one keyword selected by both the first and second advertisers, wherein the first search query is associated with the at least one keyword, b) receiving a first bid amount from each of the first and second advertisers for placement of corresponding first and second advertisements in association with the first search results list in response to the first search query, c) determining whether the first and second advertiser should cooperate on bids for placement of the first and second advertisements in association with the first search results list in response to the first search query associated with the at least one keyword, and d) if the first and second advertisers should cooperate on bids, determining a first amount for the first advertiser to bid during a first time period and a second amount for the second advertiser to bid during the first time period for placement of the first and second advertisements in association with the first search results list in response to the first search query, wherein the first and second advertisers agree upon the first and second amounts and the first time period, otherwise, continuing individual bidding by the first and second advertisers for placement of the first and second advertisements in association with the first search results list in response to the first search query.

In accordance with yet another aspect of the present exemplary embodiment, a computer program product for use with an apparatus for coordinating bids from a first advertiser and a second advertiser for placement of at least one advertisement in association with a first search results list, wherein the first search results list is generated in response to a first search query, is provided. The computer program product includes: a computer usable medium having computer readable program code embodied in the medium for causing: i) receiving at least one keyword selected by both the first and second advertisers, wherein the first search query is associated with the at least one keyword, ii) receiving a first bid amount from each of the first and second advertisers for placement of corresponding first and second advertisements in association with the first search results list in response to the first search query, iii) determining whether the first and second advertiser should cooperate on bids for placement of the first and second advertisements in association with the first search results list in response to the first search query associated with the at least one keyword, and iv) if the first and second advertisers should cooperate on bids, determining a first amount for the first advertiser to bid during a first time period and a second amount for the second advertiser to bid during the first time period for placement of the first and second advertisements in association with the first search results list in response to the first search query, wherein the first and second advertisers agree upon the first and second amounts and the first time period, otherwise, continuing individual bidding by the first and second advertisers for placement of the first and second advertisements in association with the first search results list in response to the first search query.

### BRIEF DESCRIPTION OF THE DRAWINGS

The exemplary embodiment may take form in various components and arrangements of components, and in various steps and arrangements of steps. The drawings are only for purposes of illustrating preferred embodiments and are not to be construed as limiting the exemplary embodiment.

FIG. 1 is a block diagram of an exemplary embodiment of a keyword searching environment;

FIG. 2 is a block diagram of an exemplary embodiment of a keyword advertisement management system within the keyword searching environment of FIG. 1;

FIG. 3 is a block diagram of another exemplary embodiment of a keyword searching environment;

FIG. 4 is a block diagram of yet another exemplary embodiment of a keyword searching environment; and

FIG. 5 is a block diagram of still another exemplary embodiment of a keyword searching environment;

FIG. 6 is a block diagram of still yet another exemplary embodiment of a keyword searching environment;

FIG. 7 is a flowchart of an exemplary bid optimization process for bidding on placement of keyword advertisements in a search results list; and

FIG. 8 is a flowchart of an exemplary bidding coordination service for cooperative bidding among multiple advertisers for placement of keyword advertisements in a search results list.

### DETAILED DESCRIPTION

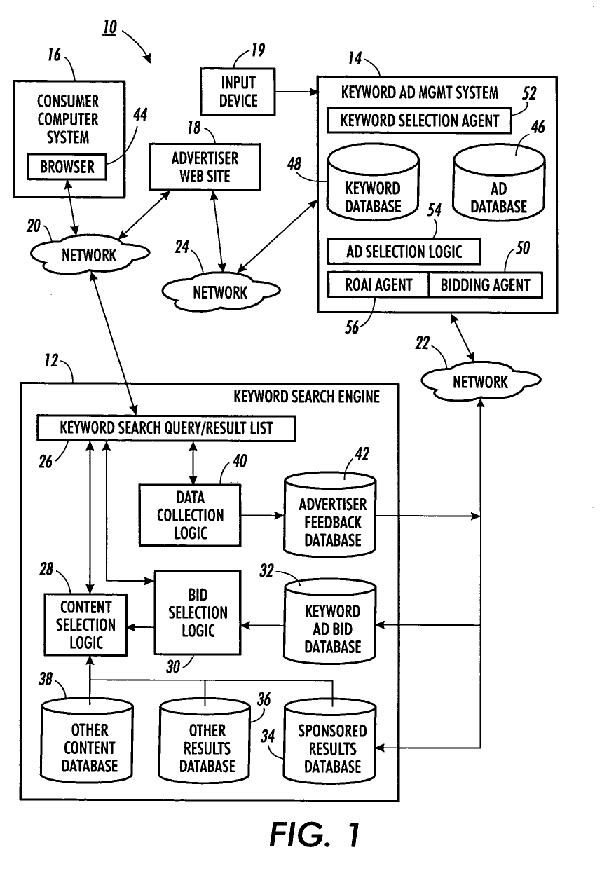

FIG. 1 depicts an exemplary embodiment of a keyword searching environment 10 where bids by one advertiser may elicit a change in bidding strategy of other bidders. As will be appreciated from the following discussion, the keyword searching environment 10 is initially described with a focus to use of client-based keyword advertisement management within the environment. A subsequent discussion relates how the environment may implement server-based keyword advertisement management. The exemplary embodiment of the keyword searching environment 10 includes a keyword search engine 12 and a keyword advertisement management system 14. This embodiment describes a process of positioning keyword advertising in association with or within a regular search results list generated by the keyword search engine 12 in response to a keyword query from, for example, a consumer computer system 16. It finds application in conjunction with generation of bids by the keyword advertisement management system 14 for positioning of the keyword advertising in the list. The bids may be based on information collected from an advertiser web site 18, information from a user associated with the advertiser via an input device 19, and feedback information associated with ongoing keyword searching from the keyword search engine 12.

The keyword search engine 12, consumer computer system 16, and advertiser web site 18 communicate via a first network 20, such as the Internet. However, any form of network suitable for data communication may be implemented. The keyword advertisement management system 14 communicates with the keyword search engine 12 via a second network 22 and the advertiser web site 18 via a third network 24. The second and third networks 22, 24 may also be implemented via the Internet or any other network suitable for data communication. As such, the first, second, and third networks or any combination thereof may be a common network or as the independent networks depicted.

The keyword search engine 12 includes a keyword search query/result list process 26, a content selection logic process 28, a bid selection logic process 30, a keyword advertisement bid database 32, and a sponsored results (i.e., advertisement) database 34. The keyword search engine 12 may also include one or more of an other results (e.g., non-paid search results) database 36, an other content (e.g., news, information, entertainment, etc.) database 38, a data collection logic process 40, and an advertiser feedback (e.g., keywords used in previous search queries, advertisements displayed in previous search results lists, click-through information for previous search results lists, and descriptive information about consumers that submitted previous search queries, etc.) database 42. Each of these processes and databases may be implemented by any suitable combination of hardware and/or software. One or more of the processes and databases may be combined in any suitable arrangement of hardware and/or software.

The consumer computer system 16 includes a browser process 44, such as Microsoft's Internet Explorer, Netscape, or another similar browser process. The browser process 44 provides users of the consumer computer system 16 with a user interface to submit keyword search queries to the keyword search engine 12 and to display the results generated by the keyword search engine 12 in response to such queries.

The keyword search query/result list process 26 receives a keyword search query from the browser process 44 and communicates the keywords to the content selection logic 28, bid selection logic 30, and the data collection logic 40. The bid selection logic 30 uses advertiser bids for keyword advertisements stored in the keyword advertisement bid database 32 to determine which keyword advertisements will be included in the keyword search results list and the position of such advertisements. This information is communicated to the content selection logic process 28. The content selection logic process 28 selects the appropriate keyword advertisements from the sponsored results database 34, as well as other appropriate content for keyword search results list from the other results database 36 and the other content database 38. The content selection logic 28 communicates the appropriate content to the keyword search query/result list process 26. The keyword search query/result list process 26 compiles the keyword search results list. The result list is communicated to the user at the consumer computer system 16 via the first network 20 and displayed to the user by the browser process 44. The keyword search query/result list process 26 also communicates information associated with the result list to the data collection logic process 40 for storage in the advertiser feedback database 42.

The keyword advertisement management system 14 includes an advertisement database 46, a keyword database 48, and a bidding agent 50. The keyword advertisement management system 14 may also include one or more of a keyword selection agent 52, an advertisement selection agent 54, and an ROAI agent 56. Each of these agents and databases may be implemented by any suitable combination of hardware and/or software. One or more of the agents and databases may be combined in any suitable arrangement of hardware and/or software.

Of course, the keyword searching environment 10 can be expanded to include a plurality of consumer computer systems 16 in communication with the first network 20. Likewise, the keyword searching environment 10 can be expanded to include a plurality of keyword search engines 12 in communication with the first network 20. Any number of the plurality of keyword search engines 12 may also be in communication with the keyword advertisement management system 14. Similarly, the keyword searching environment 10 can be expanded to include a plurality of keyword advertisement management systems 14, each in communication with a corresponding advertiser web site 18 and one or more of the plurality of keyword search engines 12.

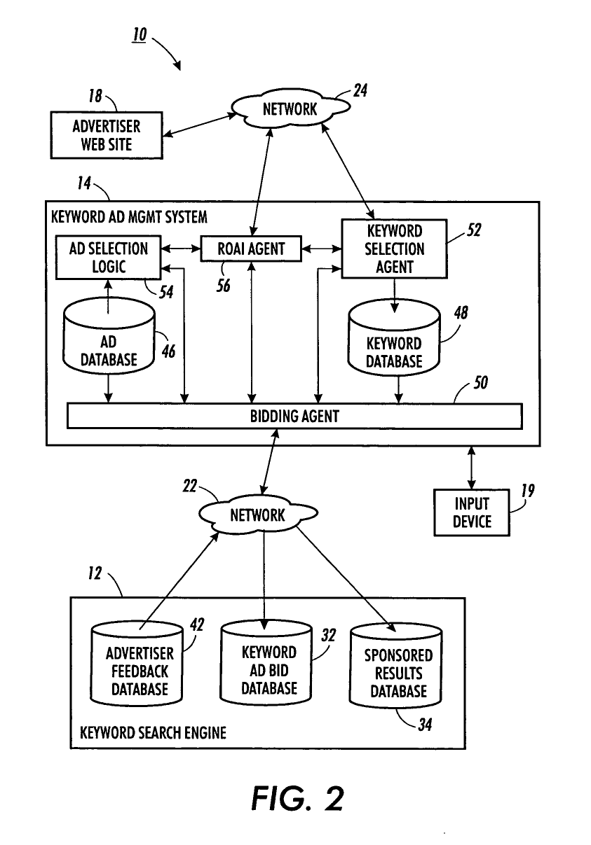

With reference to FIG. 2, the bidding agent 50 of the keyword advertisement management system 14 receives information from the advertiser feedback database 42 in the keyword search engine 12 and matches keywords and keyword combinations in the keyword database 48 with keyword advertisements in the advertisement database 46. For each keyword/keyword combination, the bidding agent 50 selects a corresponding keyword advertisement and determines a bid to be submitted to the keyword advertisement bid database 32 in the keyword search engine 12. The bid is based on information available to the bidding agent 50 and an optimized bidding strategy algorithm. For example, in addition to the information from the keyword search engine 12, any of a plurality of parameters considered by the optimized bidding strategy algorithm and other settings within the algorithm may be provided by a user via a suitable input device 19. The user information may include the advertisement to be selected, the plurality of keywords to be selected, the one or more keywords to be associated with the bid, a maximum bid, a minimum bid, a plurality of bids ranging between a maximum bid and a minimum bid, a range for bids, and various related information. Additionally, an “aggressiveness” setting may be incorporated in the optimized bidding strategy algorithm with respect to sales and visitor data, ROAI, current and historical bidding data (including data from other advertisers). In particular, the user may interact with the algorithms to approve or confirm a recommendation, to make a specific selection from a group of recommended selections, to specify an alternate selection in lieu of one or more recommended selections, and various other related interactions.

As part of the bidding strategy of a user, the present system will allow a first advertiser who has associated at least one keyword with the bid which is to be entered to determine an amount of the bid for placement of a first advertisement within the search results list, where the first advertiser's bid is determined in order to elicit a change in bids by other advertisers in competition with the first advertiser. Particularly, therefore, the present system permits sophisticated bidding by users of the system, as opposed to the static environment of existing bidding environments, such as in Google, Overture or other auction provides. As used herein, the concept eliciting a change as to other advertisers, would include the general concepts of causing the other advertisers to increase a bid, decrease a bid, remove themselves from the present auction, and attempt to enter other auctions, among others. The sophisticated bidding permits a user of the present system to react to real world competitive situations, which is not obtainable by the static bidding concepts of Google, Overture and other providers.

For example, while bid adjustment features exist in Google, the bidding changes occur due to operations of Google, i.e., the provider, and not by other bidders in reaction to a first bidder. For example, Google will adjust a party's bid down to the level it would have been necessary to win the bid. For example, if a party in second place of an auction bids $2.00, and a third-place bidder bid $1.00, the bid adjustment feature of Google would move the second bidder down to $1.01.

The more sophisticated bidding techniques presented in the present application, permit an advertiser, therefore, as mentioned, to actively address competitive real world bidding situations.

For example, the advertiser of the present embodiments would have more of an effect and flexibility in a bidding war, which is understood to be a situation where bids are raised as high as necessary for a specific party to win a first position. At times, this may be a temporarily high bid which is not justified by profits obtained, but may be necessary due to business considerations. Therefore, this strategy may be employed to make other bidders satisfied with winning a second or lower placement, or have been determined to find other keywords for use in advertising placement.

Another situation where a sophisticated bidding ability is beneficial is when no other bidders exist in an auction. However, a sophisticated bidder may understand that a minimum bid to win the auction may not be desirable, as it may draw other bidders into the market. Therefore, where a user may have an economic benefit of making a bid of $2.00, but no other bidders exist and they could win the auction at $0.50, the more sophisticated bid may be to place this bid at $1.00 to foreclose others from entering the auction. As a corollary, a bidder in an auction may abruptly raise a bid higher than normal profits would justify in order to discourage other bidders already in the market from competing. Here again, the behavior that is elicited is that the other bidders may drop out of the auction.

Another bidding technique may be one of altering a bid from a high bid one day to win a specific place in the results list, and a lower bid a next day to concede that placement. This strategy may elicit a behavior from another bidder, which may also become an alternate bidding, on days of winning the first position and alternating on other days to win a lower position.

Yet still another bidding strategy may be to set a bid only slightly less than a second bidder in order to test the second bidder.

It is to be understood that the foregoing details merely relate several of a multitude of bidding strategies which may be implemented in accordance with the technical teachings described herein in order to elicit bidding changes from competitive advertisers.

The keyword selection agent 52, advertisement selection agent 54, and ROAI agent 56 may be implemented in the keyword advertisement management system 14 individually or in any combination. Each of the keyword selection agent 52, advertisement selection agent 54, and ROAI agent 56 is in communication with the bidding agent 50 and all four agents can share information. Like the bidding agent 50, any or all of the other agents may receive user information associated with parameters or settings in the corresponding algorithm from a user via a suitable input device 19.

The keyword selection agent 52 includes an algorithm for selection of keywords and keyword combinations that are included in the keyword database 48. The keyword selection agent 52 may receive, for example, content information from the advertiser web site 18, user information from the input device 19, and keyword information from the advertiser feedback database 42. The advertisement selection agent 54 includes an algorithm for selection of an advertisement from the advertisement database 46 that is to be matched with a given keyword or keyword combination. The ROAI agent 56 includes an algorithm that provides an estimate of return on investment for one or more bids or a range of bids associated with a given keyword/keyword combination and matched keyword advertisement. The ROAI agent 56 may receive, for example, click-through information associated with a given keyword/keyword combination and matched keyword advertisements from the advertiser feedback database 42, user information from the input device 19, and sales information from the advertiser web site 18.

There are also synergistic effects within the keyword advertisement management system 14 in that the bidding agent 50 and the optimized bid strategy can be based on the results produced by the keyword selection agent 52, advertisement selection agent 54, and/or ROAI agent 56. Likewise, the results of the keyword selection agent 52, advertisement selection agent 54, and ROAI agent 56 can be based on results from one or more of the other agents in addition to the external information collected from the advertiser web site 18, user input device 19, and advertiser feedback database 42.

For example, the algorithm in the keyword selection agent 52 can select optimized keywords: i) based on the content of the advertiser web site 18, ii) for each advertisement in the advertisement database 46 based on the content of the advertisement, iii) based on the frequency that certain keywords are included in queries to the keyword search engine, iv) from information provided by the advertiser feedback database 42 in the keyword search engine 12, v) from information provided via input device 19, and/or vi) from information provided by other relevant sources. Similarly, the algorithm in the advertisement selection agent 54 can select optimized advertisements: i) based on optimized keyword selection, ii) based on optimized ROAI, iii) from information provided via input device 19, iv) from information provided by the advertiser feedback database 42, and/or v) from information provided by other relevant sources. The accumulative synergistic effect is that the algorithm in the bidding agent 50 can determine optimized bids for keyword advertising: i) based on optimized keyword selection, ii) based on optimized advertisement selection, and/or iii) based on optimized ROAI.

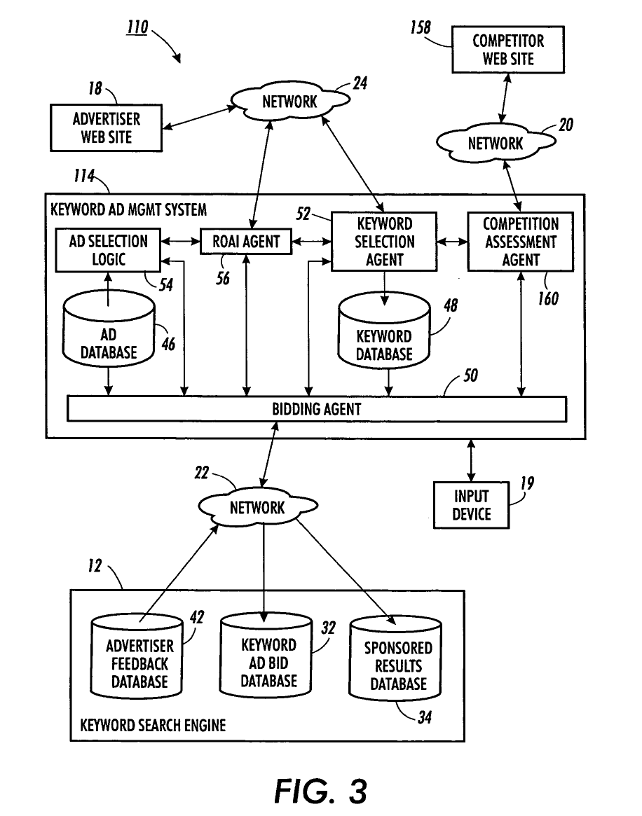

With reference to FIG. 3, another embodiment of a keyword searching environment 110 includes the keyword search engine 12, advertiser web site 18, first network 20, second network 22, third network 24, a keyword advertisement management system 114, and a competitor web site 158. The keyword searching environment 110 generally operates as described above in reference to FIGS. 1 and 2. Of course, the keyword searching environment 110 can be expanded to include a plurality of competitor web sites 158 in communication with the first network 20.

The keyword advertisement management system 114 includes a competition assessment agent 160 in addition to the components described above in reference to FIGS. 1 and 2. The competition assessment agent 160 includes an algorithm for collection information from the competitor web site 158 via the first network 20. The competition assessment agent 160 analyzes the content of the competitor web site and may utilize the keyword selection agent 52 and/or ROAI agent 56 to estimate optimized keywords and/or ROAI for the competitor. The competition assessment agent 160 may also receive, for example, keyword search engine information from the advertiser feedback database 42, user information from the input device 19, and other information about the competitor from the competitor web site 158.

The synergistic effects within the keyword advertisement management system 114 are amplified in that the bidding agent 50 and the optimized bid strategy can also be based on the results produced by the competition assessment agent 160 in addition to the results produced by the keyword selection agent 52, advertisement selection agent 54, and/or ROAI agent 56. Likewise, the results of the keyword selection agent 52, advertisement selection agent 54, and ROAI agent 56 can also be based on results from the competition assessment agent 160.

The preceding discussion has illustrated that pay-per-click advertising benefits advertisers (e.g., Amazon.com and Gap.com), and providers (e.g., Google and Overture), and has described scenarios where certain benefits accrue to one or the other of these groups. The following materials focus on the complex interrelationship between these parties, and a market maximization mechanism, implemented by a provider that a) credibly induces full cooperation from advertisers in order to create a maximum or near maximum total available profit for a market, and then b) “splits” the profit in an automated fashion with the advertisers, by a procedure, the advertisers perceive to be fair and equitable.

The market maximization mechanism, which is a software logic system contained on the keyword advertisement management system 14 of a provider, can calculate the profit accruing to advertisers as follows. For all keywords in which the advertiser participates: P(advertiser)=SearchVolume (keyword)×ClickthruRate (keyword, advertisement, RankPlacement)×(ROAI (keyword, advertisement, [landpage])−CPC (keyword, RankPlacement)). Where, “keyword” is the word or words that a user types into the search box to obtain search results, “advertisement” is the word, words, and/or images, some or all hyperlinked, that explain the advertiser's offering to the user, and which entices the user to click to learn more about the offering, “RankPlacement” is the location or rank of the advertisement, relative to other advertisements and other content on the results screen, “[landpage]” is an optional parameter that specifies the URL in which the user “lands” after the advertisement is clicked. In this manner, different purchasing experiences can be provided to the user. SearchVolume (keyword) is the number of searches that occur on the particular keyword during a given period of time, ClickthruRate (keyword, advertisement, RankPlacement) is the percentage of time that users click on the advertisement that is presented to them, for a given keyword, ROAI (keyword, advertisement, [landpage]) is the Revenue Per Click that can be expected when a customer a) searches by the given keyword, b) experiences the given advertisement, and c) gets directed to the given [landpage]. The ROAI is generated from historical purchase data, associated with historical keyword/advertisement/[landpage] data, and CPC (keyword, RankPlacement) is the Cost Per click associated with presenting any advertisement in the position specified by RankPlacement, in response to a specific keyword as submitted by a user into a search box.

Similarly, the profitability of the provider is calculated as follows. For all keywords being auctioned by the provider: P(provider)=SearchVolume(keyword)×ClickthruRate (keyword, advertisement, RankPlacement)×CPC (keyword, RankPlacement).

In implementation, the advertiser will seek to maximize P(advertiser) while the provider will seek to maximize P(provider). However, the market maximization mechanism of keyword advertisement management system 14 takes advantage of the interrelationship between both parties, in which they need each other's cooperation, at some level, in order to create profit for themselves.

Concerning this interrelationship and co-dependency, the following table outlines various parameters that drive the profit level of the provider and the advertiser, and which party “controls” each parameter.

| | Controlled by: | | | |
|---|---|---|---|---|
| | | | Other | |
| Parameter | Prov. | Adv. | Adv's | Users |

| | | | |
|---|---|---|---|
| Keyword | X | | |
| Advertisement | X | | |
| RankPlacement (determined by bid amt) | X | | |
| [LandPage] | X | | |
| SearchVolume(Keyword) | | | X |
| ClickthruRate (keyword, | | | X |
| advertisement, RankPlacement) | | | |
| ROAI(keyword, advertisement, [land | | | X |
| page]) | | | |
| CPC(keyword, RankPlacement) | X | X | |

As can be seen, the provider has very little direct control of explicit parameters. In fact, the table emphasizes that the CPC, a major drive of profitability for the advertiser, is actually controlled collectively by the pool of advertisers. This collective capability to control the cost of a scarce resource (an advertisement impression in a given location at a given moment in time) is what gives rise to the auction mechanism.

Assuming, for this embodiment, there is no cooperative behavior among the pool of advertisers, the market maximization mechanism of keyword advertisement management system 14 can be implemented by a provider that simultaneously optimizes its own profit while simultaneously and credibly optimizing advertisers' profit. A first embodiment for such mechanism is now detailed.

If the advertiser and provider can agree on a single mechanism that optimizes the interests of both parties, it makes sense to implement and automate such a mechanism. Because the search system is located with the provider, it also makes sense for the provider to be the party that invests in, implements, and maintains the automation mechanism, although for the purposes of this disclosure it should be appreciated that the mechanism could be implemented by the advertiser or a third party as well. Although this automation saves the advertisers the cost (in terms of time & labor) required to manually enter and update bids, the more significant value is that it finds and instantly exploits opportunities of cooperation that are mutually beneficial to the provider and the advertiser.

Process 1: Computing Optimal Total Profit. Initially, the business axiom that a market must be created and its size must be maximized before profitability is assigned to various members of an industry or value chain must be appreciated. Therefore, prior to the maximization of total profit the mechanism must express total profit as the sum of the profit of the provider plus the sum of the profit of each advertiser, as in the following: P(total)=P(provider)+P(advertiser)=[SearchVolume (keyword)×ClickthruRate (keyword, advertisement, RankPlacement)×CPC (keyword, RankPlacement)]+[SearchVolume (keyword)×ClickthruRate (keyword, advertisement, RankPlacement)×(ROAI (keyword, advertisement, [landpage])−CPC (keyword, RankPlacement))]=SearchVolume (Keyword)×ClickthruRate (keyword, advertisement, RankPlacement)×ROAI(keyword, advertisement, [landpage]).

Since the ClickthruRate is dependent on the RankPlacement in addition to the keyword and advertisement, an assumption is made that RankPlacement is not correlated with keyword and advertisement (this is not completely true—a very good advertisement will almost certainly receive a click as long as it is noticed, whereas a highly ranked but very poorly written advertisement will not). The total profit therefore, under this assumption, becomes: P(total)=SearchVolume (Keyword)×ClickthruRate (keyword, advertisement)×ROAI (keyword, advertisement, [landpage]).

Maximizing P(total), occurs with the maximization of the “Revenue Per Impression” for each keyword. This can be expressed as: RPI (Keyword)=ClickthruRate (keyword, advertisement)×ROAI (keyword, advertisement, [landpage]).

For each Keyword, the advertisement, [landpage] is sorted in descending order of RPI (Keyword) and each is assigned a rank. For example, for the keyword “mortgage”:

| Rank | Advertisement, [landpage] | RPI |
|---|---|---|
| 1 | (“Cheap mortgages!”, [site4.com]) | $0.52 |
| 2 | (“Click here for a house loan”, [site2.com]) | $0.48 |
| 3 | (“State Bank mortgages”, [site1.com]) | $0.38 |
| 4 | (“Mortgages-R-us”, [site5.com]) | $0.24 |
| 5 | (“Overpriced mortgages”, [site3.com]) | $0.15 |

This process is repeated for every keyword in the search space. In the above example, “Overpriced mortgages” receives a low ranking because it is not an appealing advertisement and therefore receives a low ClickthruRate.

Before the optimal (advertisement, [landpage]) can be computed for each word, two additional pieces of data are needed. The first is the ClickthruRate of each (keyword, advertisement), and the second is the ROAI of each (keyword, advertisement, [landpage]), where the advertisement and [landpage] are related to a given advertiser, and there are many advertisers for any one provider (for example, as of this writing it was estimated that Overture had 100,000 active advertiser accounts). Also, ideally, the provider would want to have the ClickthruRate of every (keyword, advertisement) and the ROAI of every (keyword, advertisement, [landpage]), as this would uncover non-obvious but profitable combinations. However, this is computationally prohibitive, and can also be quite wasteful because there will be many combinations that just don't make sense to pursue in any way (example: keyword “furniture”, advertisement “click here for helicopter parts”, landpage “irs.gov”).

Assuming therefore the space of (keyword, advertisement, [landpage]) has been bounded, there are many ways of calculating ClickthruRate and ROAI. These may include taking good initial guesses at these values, which enables the provider to begin presenting ads, and then adjusting the values based on actual collected data. Methods of taking good initial guesses include language processing techniques, asking the advertiser to supply initial guesses, based on historical data, and others. A convenient way to calculate ClickthruRate is for the provider to do so locally, after the user clicks on the ads, and before transferring the user to the [landpage]. In contrast, there are many different ways of obtaining the ROAI data, including: Passing (advertisement, keyword) data to the advertiser during the click event (such as through a tracking URL), having the advertiser associate this data with revenue data and transmitting it to the provider; asking the advertiser to place features on the advertiser's website that communicate to the provider when a revenue or other event takes place. One specific feature of this type is known as an “image bug”, another is a client-side script that communicates directly with the provider's server, and there are others.

Process 2: Splitting the Profit. It can be appreciated that there are a variety of methods to split the profit that will implement a fair and equitable splitting of the profits. For example, the provider can always set BID (keyword, advertisement, [landpage])=ROAI (keyword, advertisement, [landpage])*A+B. Where A and B can be selected by the advertiser to determine threshold of desired profit margin (which helps account for “overhead” costs that impact bottom-line profitability).

If the advertiser selects a maximum number of clicks per time period (or corresponding maximum daily budget), bids are placed in descending order of P(advertiser) until the maximum is reached: P(advertiser)=ClickthruRate (keyword, advertisement)×[ROAI (keyword, advertisement, [landpage])−CPC (keyword, RankPlacement)]. Where RankPlacement is determined solely by the BID amount. Since the BID amount is determined by ROAI, the ranking will be identical to that described in Process 1.

The above may not exploit slightly less advantageous positions that could be more profitable to the advertiser. This approach therefore, will maximize the size of the “total market profitability” P(total). Also, the provider is advantaged as it receives the highest possible bids from all advertisers; since the provider's profit is determined by CPC(keyword, RankPlacement) and RankPlacement is maximized, it follows that the provider attains maximum profit as well.

Another alternative that is more favorable to the advertiser is when bids are placed in descending order of P(advertiser), up until a maximum number of clicks per time period (or corresponding maximum daily budget) is reached or a certain profitability threshold (A and B above) is reached. For example, P(advertiser)=ClickthruRate (keyword, advertisement, RankPlacement)×[ROAI (keyword, advertisement, [landpage])−CPC (keyword, RankPlacement)].

In this approach, RankPlacement is added as an independent variable to maximize P(advertiser). This is because the constraint that BID=ROAI*A+B (as imposed in the first alternative) is relaxed to maximize the overall market, and the assumption that there is no correlation among keyword, advertisement, and RankPlacement in the determination of ClickthruRate is also relaxed. Making RankPlacement an independent variable adds the complication of calculating ClickthruRate for different RankPlacements. Further, a correlation arises between the different ClickthruRates of all the advertisements for a given keyword. Further, ambiguity may arise on what the BID amount should be for a given desired rank.

To proceed, the space of ClickthruRate is expanded to include RankPlacement. These values can be stored as an array in memory or in a database. We start with the best available calculation of ClickthruRate and make initial adjustments for Rankplacement. These initial adjustments are calculated from historical data on how a particular RankPlacement does relative to another, with or without regard to the underlying advertisement. Once the advertisements are posted and users begin to click (or not click) on the advertisement, real data can be used to make adjustments to make the data more accurate. This also begins to adjust for the correlation issues that were previously mentioned. As a result, the system self-optimizes with use.

The remaining issue is how to calculate a BID amount. This is a sensitive topic, because, for certain ranges of bid amounts, and assuming 2^{nd}-price bidding is implemented (one example of this being implemented on Overture), the amount a particular advertiser bids has no effect on that advertiser, but directly impacts the CPC of other advertisers. Here is an example:

| Advertiser | Bid Amount | CPC |
|---|---|---|
| #1 | $1.00 | $0.91 |
| #2 | $0.90 | $0.75 |
| #3 | $0.74 | $0.40 |
| #4 | $0.39 | $0.10 |
| | | (minimum bid) |

In the above cases, advertiser #2 could have lowered his bid to $0.75 without impact to himself, but would have lowered #1's cost to $0.75 per click. Similarly for advertiser #3 and #4. If the optimization system decides to add a new advertiser between #2 and #3, the bid amount can be anywhere between $0.75 and $0.89. While there are many approaches to this ambiguity, a provider could make an argument for maximizing the bid ($0.89 in this example), because it maximizes the profit of the provider and it has no effect on the advertiser whose bid is being automatically modified. Obviously, the policy itself ultimately does impact all advertisers in aggregate.

Thus the above optimization occurs on a periodic basis for all advertisers and their keywords, advertisements, etc. Therefore, the use of the described market maximization mechanism will operate to maximize or nearly maximize total market profitability while providing an automated splitting of profits among the provider and advertisers.

At this point the concept of pay-per-click context-based advertising should be mentioned. The only difference between pay-per-click search-based advertising and pay-per-click context-based advertising is that context-based advertisements are generated as a result of the user selecting a particular page of content to view, as opposed to submitting a keyword for search results. For example, a New York Times travel article being viewed by a web user through a web browser might carry context-based pay-per-click advertisements on hotels or travel agents. Both Google and Overture currently offer this type of advertising.

For purposes of the above discussions on optimization, a “keyword” can be substituted with a “publisher-page” in the algorithm pairing keywords with advertisements, where the “publisher-page” is a unique web page. Obviously, because a keyword is different from a whole web page, the techniques for generating initial guesses on ClickthruRate will vary.

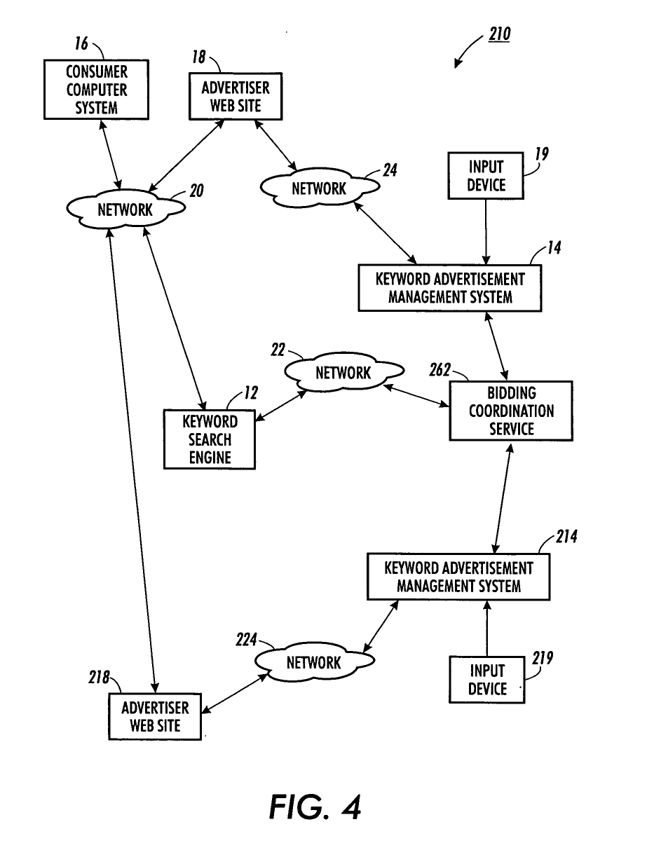

With reference to FIG. 4, yet another embodiment of a keyword searching environment 210 includes the keyword search engine 12, keyword advertisement management system 14, consumer computer system 16, advertiser web site 18, input device 19, first network 20, second network 22, third network 24, a second keyword advertisement management system 214, a second advertiser web site 218, a second input device 219, a fourth network 224, and a bidding coordination service 262. The keyword searching environment 210 generally operates as described above for the keyword search environments 10, 110 of FIGS. 1-3.

The second keyword advertisement management system 214 generally operates in the same manner as described above for the original keyword advertisement management system 14. The second advertiser web site 218 operates in the same manner as described above for the original advertiser web site 18. The second input device 219 operates in the same manner as described above for the original input device 19. The fourth network 224 operates in the same manner as described above for the third network 24. As discussed above, any of the four networks may be combined in one or more networks and any type of network suitable for data communication may be implemented for any of the four networks or any combination of networks.

The bidding coordination service 262 communicates with the first keyword advertisement management system 14 and the second keyword advertisement management system 214. The bidding coordination service 262 includes a bidding agent and group optimization logic that coordinates bids for keyword advertisement positions for a group including at least a first advertiser associated with the original keyword advertisement management system 14 and a second advertiser associated with the second keyword advertisement management system 214. The group optimization logic establishes time frames when advertisements associated with the first and second advertisers will be associated with a cooperative bid for placement of the advertisement in a search results list associated with a certain keyword or keyword combination. This cooperative bidding arrangement permits each advertiser to receive advertisement time. Conceivably, the bids associated with this form of cooperative advertising are lower than individual bids which would be made by advertisers in the group. Thus, advertisement costs for members of the group may be reduced.

In other words, for example, the results from the bidding agent 50, keyword selection agent 52, advertisement selection agent 54, and ROAI agent 56 in each keyword advertisement management system may be communicated to the bidding coordination service 262. The group optimization logic evaluates the bids from advertisers in the group and formulates cooperative strategies for sharing time and adjusting bids. Additionally, the group optimization logic may also suggest alternate keywords for certain advertisers in the group. Once the cooperative bidding strategy is established, the bidding agent in the bidding coordination service 262 submits bids to the keyword search engine 12 via the second network 22. The bidding agent in the bidding coordination service 262 generally operates in the same manner as the bidding agent in the keyword management systems. Thus, the bidding process and information exchanged between the bidding coordination service 262 and the keyword search engine 12 is generally the same as described above with respect to the keyword advertisement management system. This creates a cooperative environment for a group of advertisers and results in advertising time and expenses that are mutually beneficial to the advertisers in the group.

In one embodiment, coordination between advertisers associated with the advertiser group in the cooperative environment includes compression of the bidding space. For example, if there are five bids of $0.10, $0.50, $0.75, $1.00, and $1.50 for positions of five corresponding advertisements associated with a search results list and five advertisers associated with the five 5 bids are cooperating, an effective joint strategy is for each advertiser to bid $0.01, $0.02, $0.03, $0.04, and $0.05, respectively. Note that the exact same bidding order is maintained and the cost to each advertiser is drastically reduced.

In more general terms, in the cooperative environment a plurality of bids is coordinated for placement of a corresponding plurality of advertisements in association with the search results list for a corresponding plurality of advertisers in the advertiser group. The joint strategy for the advertiser group includes coordinating compression of the plurality of bids to reduce related advertising costs for at least one of the plurality of advertisers.

In one embodiment, coordination between advertisers associated with the advertiser group in the cooperative environment includes coordinating the exchange of rewards for cooperating. Including, for example, calculating or recommending the nature, type, and/or amount of such rewards. This may include side payments, providing mutual links on advertisers' web sites, and many other forms of rewards.

In more general terms, coordinating bids for a group of advertisers includes coordinating exchange of rewards between advertisers in the advertiser group for cooperating and calculating at least one of a type of the rewards and an amount of the rewards or recommending at least one of a type of the rewards and an amount of the rewards.

In one embodiment, coordination between advertisers associated with the advertiser group in the cooperative environment includes providing a conduit for negotiation and/or relationship-building between the advertisers. This may include a shared message area, a private messaging area, or other similar forms of collaborative messaging environments (e.g., chat rooms, mailing lists, message forums, etc.).

In more general terms, coordinating bids for a group of advertisers includes exchanging information between the advertisers in the advertiser group. The exchanged information may be used, for example, for negotiation or relationship building. The information may be exchanged, for example, via a shared messaging area, a private messaging area, a collaborative messaging environment, a chat room, a mailing list, or a message forum.

In one embodiment, coordination between advertisers associated with the advertiser group in the cooperative environment includes managing a temporary breakdown of cooperation. For example, if a particular advertiser temporarily forgets to act in a cooperative manner, the system automatically adjusts future rotations, payments, or other forms of cooperation to account for non-compliance. The effect is that “noise” is minimized and escalation of non-cooperation is prevented.

In more general terms, coordinating bids for a group of advertisers includes adjusting a joint strategy when one or more advertiser in the advertiser group does not implement a devised, recommended, or agreed upon joint strategy. For example, a recommended bid or a recommended time associated with the bid may be adjusted for one or more advertisers in the advertiser group in the adjusted joint strategy.

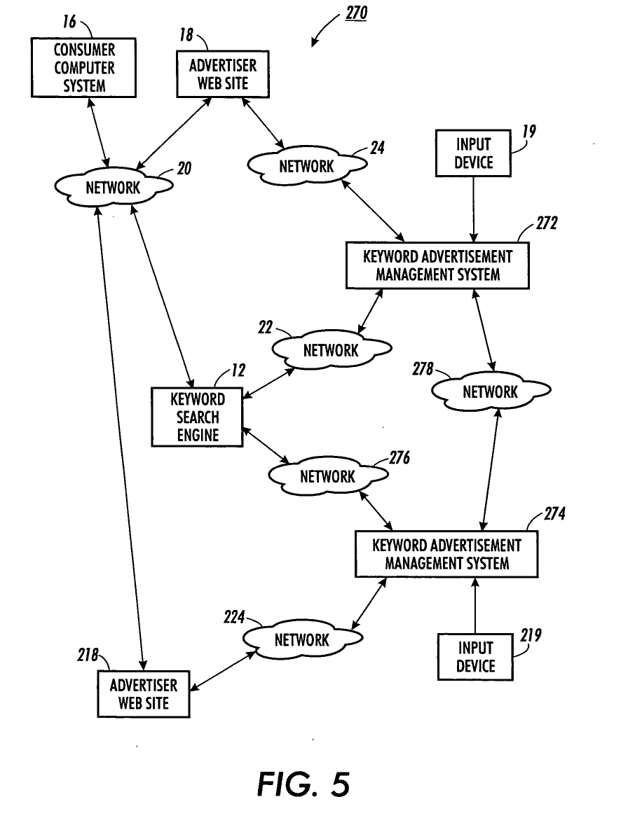

With reference to FIG. 5, yet another embodiment of a keyword searching environment 270 includes the keyword search engine 12, consumer computer system 16, advertiser web site 18, input device 19, first network 20, second network 22, third network 24, second advertiser web site 218, second input device 219, fourth network 224, a first keyword advertising management system 272, a second keyword advertising management system 274, a fifth network 276, and a sixth network 278. The keyword searching environment 270 generally operates as described above for the keyword search environments 10, 110, 210 of FIGS. 1-4.

The first and second keyword advertisement management systems 272, 274 generally operate in the same manner as described above for the original keyword advertisement management system 14. The second advertiser web site 218 operates in the same manner as described above for the original advertiser web site 18. The second input device 219 operates in the same manner as described above for the original input device 19. The fourth network 224 operates in the same manner as described above for the third network 24. The fifth network 276 provides a means for communication between the keyword search engine 12 and the second keyword advertisement management system 274 and operates in the same manner as described above for the second network 22. The sixth network 278 provides a means for communication between the first keyword advertisement management system 272 and the second keyword advertisement management system 274. As discussed above, any of the six networks may be combined in one or more networks and any type of network suitable for data communication may be implemented for any of the six networks or any combination of networks.

The group optimization logic described above in reference to the bidding coordination service 262 of FIG. 4 is included in both the first and second keyword advertisement management systems 272, 274. This permits advertiser groups to be formed like those described above in reference to FIG. 4. The group optimization logic provides peer-to-peer communications between members of an advertiser group via the sixth network 278. This permits shared information for use in any or all of the various algorithms within keyword advertisement management systems 272, 274. In other words, for example, the results from the bidding agent 50, keyword selection agent 52, advertisement selection agent 54, and ROAI agent 56 in one keyword advertisement management system may be communicated to other keyword advertisement management system and used by algorithms in one or more agents of the system receiving such information. This can create a cooperative environment for a group of advertisers much like the cooperative environment depicted in FIG. 4. However, in the cooperative bidding environment of FIG. 5, members of the group continue to submit individual bids for keyword advertising positions in the manner described above in reference to FIGS. 1-3.

The keyword searching environments 210, 270 of FIGS. 4 and 5 provide bidding coordination services to advertiser groups. Such bidding coordination services accept information from individual advertisers belong to the advertiser group (i.e., subscribers to the service) and either suggests bidding strategies for the individual advertisers or automatically implements a joint bidding strategy for the advertiser group.

There are several situations where it is beneficial for advertisers to cooperate in their advertising strategies. For example, when advertisers have interests in various keyword combinations it may be beneficial for advertisers to seek combinations where there is less overlapping interest with their competitors.

In other words, it may make more sense to find different keywords for advertising that pay large click-through costs for highly contested keywords. A potentially beneficial joint strategy would be to have advertisers move to less contested keywords. As another example, when a small number of advertisers are bidding for the same keyword combination, rather than competing until they have all bid close to their expected return on a click-through, and therefore are paying large amounts for their advertising, a more economical joint strategy could be to rotate who wins the bidding at a lower cost.

These mutually beneficial joint strategies may be difficult for individual advertisers to identify, since individuals do not usually have accurate information on the utility of keywords for their competitors. Moreover, even in situations where joint strategies can be identified it may be difficult to implement these strategies because they presume that all bidders are rational and will identify the same joint strategy. For example, for a particular contested set of keywords, it may be obvious to 4 out of 5 bidders that it would be better to rotate winning near $0.50, rather than always winning at $3.00, however if 1 of the 5 bidders does not understand this strategy the cooperation is jeopardized. Even when all players are able to identify a mutually beneficial joint strategy, there may not be an incentive for individuals to use the strategy (that is, in game theory terms, the strategy is not an equilibrium strategy). A coordination service can greatly increase the possibility that a jointly beneficial strategy will be followed by identifying the strategy for all participants, and increasing the credibility that individuals will benefit by cooperating. The continuous nature of these auctions means that they resemble an iterated prisoners dilemma game, which is known to have stable cooperative strategies as long as there is a threat of retaliation for lack of cooperation (often, in game theory, referred to as punishment for defection). In this situation the coordination service can further increase the likelihood of cooperation by increasing the credibility that non-participants will be disadvantaged, and by coordinating the remaining cooperating bidders to share the cost of addressing the defector.

In real world situations like this, it is important that participants do not interpret accidents and noise as noncooperative behaviour. For example, if the joint strategy is to rotate the winner, and one participant forgets to adjust their bid, then the cooperation may be jeopardized. The coordination service can reduce the sensitivity of the joint strategy to accidents and noise by dynamically adjusting the rotation to repair these errors. Moreover, these kind of adjustments can also be used to accommodate different bidding habits—i.e., an individual who adjusts bids weekly can still rotate with individuals adjusting bids more frequently.

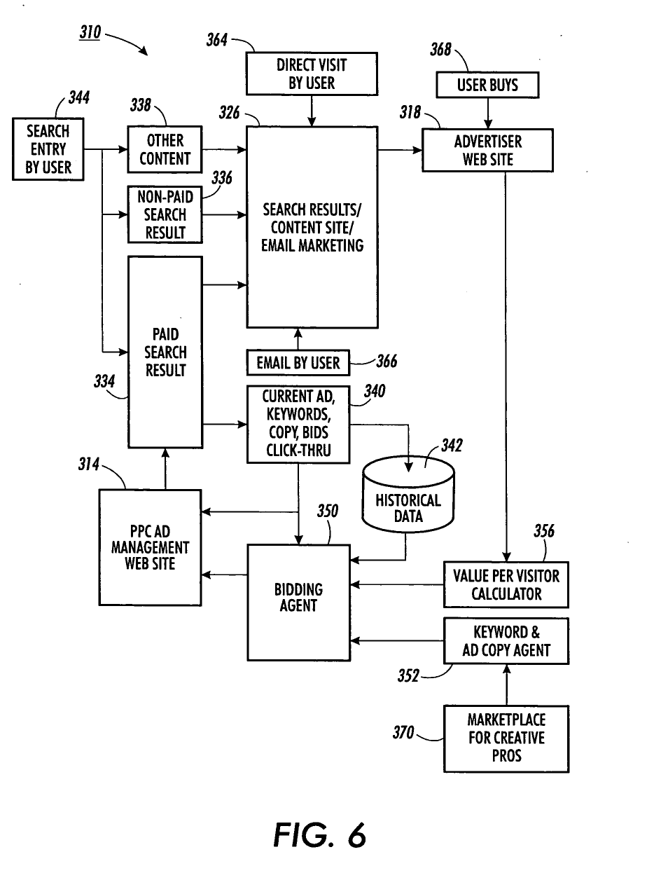

With reference to FIG. 6, another embodiment of a keyword searching environment 310 includes a PPC advertisement management web site 314, an advertiser web site 318, a search results/content site/email marketing process 326, a paid search results database 334, a non-paid search results database 336, an other content database 338, a current advertisement, keywords, copy, bids, and click-through data collection process 340, a historical data database 342, a search entry by user process 344, a bidding agent 350, a keyword and advertisement copy agent 352, a value per visitor calculator process 356, a direct visit by user process 364, a email by user process 366, a user buys process 368, and a marketplace for creative professionals database 370.

The PPC advertisement management web site 314 manages selection of advertisements from the paid search results database 334 in response to keywords submitted by the search entry by user 344 to the paid search results database 334. The advertisements, as well as other results from the non-paid search results database 375 and other content from the other content database 376, are provided to the user in the search results/content site/email marketing process 373. The user typically clicks on a link in the search results and advances to the advertiser web site 372 associated with that link. From the advertiser web site 372, the user may purchase goods or services via the user buys process 385.

The paid search results database 374 may also communicate information associated with the keyword search, search results, and user actions to the current advertisement, keywords, copy, bids, and click-through data collection process 377. The data collection process 377 may store this information in the historical data database 378.

The value per visitor calculator process 382 may receive impression, click-thru data, user, sales, and other relevant information from the advertiser web site 372 to determine financial information associated with ROAI for the advertiser that may be associated with keywords and/or advertisements.

The marketplace for creative professionals database 386 is essentially a collection of advertisements and advertising information associated with the advertiser. The marketplace for creative professionals database 386 provides the advertisements and related information to the keyword and advertisement copy agent 381 for identification of keywords associated with each advertisement.

The bidding agent 380 uses information received from the data collection process 377, historical data database 378, keyword and advertisement copy agent 381, and value per visitor calculator process 382 to determine bids for each keyword and advertisement combination. The resulting bids, as well as information from the data collection process 377, are communicated to the PPC advertisement management web site 371. At this point, the keyword searching environment 370 stands ready to respond to search entries by users with search results that include keyword advertisements positioned according to their bid ranking.

The above description of FIGS. 1-6 primarily explains the client-based implementation. As previously noted, FIGS. 1-6 are also adaptable to a server-based implementation because. for example, the advertiser web site 18 or input device 19 may provide advertisers with remote access to a server-based keyword advertisement management system 14.

In the server-based implementation, the keyword advertisement management system may be co-located with the keyword search engine or installed in a location more distant from the keyword search engine. In the server-based implementation, advertisers preferably access the keyword advertisement management system using an advertiser computer system with a browser. However, any combination of equipment and software suitable for remote operation may be used. Advertisers may use any suitable means for accessing the server-based keyword advertisement management system, including various types of network connections, Internet service providers, and/or dial-up connections. The search engine company or advertising aggregator may accept bids from the server-based keyword advertising management system as well as bids provided by conventional means. Advertisers using the keyword advertisement management system would have an advantage over advertisers using conventional means for bidding. In the server-based implementation, the keyword search engine information is typically readily available to the keyword advertisement management system, while special arrangements may need to be made in order for the system to have access to advertiser web site information, particularly sales information attributed to a click-through from a keyword advertisement.

In the client-based implementation, the keyword advertisement management system is typically located at an advertiser facility that is usually distant from the keyword search engine. In this implementation, advertisers preferably install the keyword advertisement management system on a computer network accessible to various computers authorized to use the network. However, the keyword advertisement management system may also operate on a stand-alone computer. The stand-alone computer may act as a server or a master to one or more remote computers. The search engine company or advertising aggregator may accept bids from the client-based keyword advertising management system as well as bids provided by conventional means. Of course, the advertisers using the client-based keyword advertisement management system would have an advantage over advertisers using conventional means for bidding. In the client-based implementation, the advertiser web site information and the user information is typically readily available to the keyword advertisement management system, while special arrangements may need to be made in order for the system to have access to the keyword search engine information.

Referring to FIGS. 1-6 more generally, the keyword advertisement management system assists an advertiser or vendor in specifying when advertisements should be presented and how much should be paid for these presentations. The keyword advertisement management system provides techniques for keyword advertising management that integrate one or more of: 1) content analysis of an advertiser's advertisement copy and associated web site, 2) tracking return on advertising investment (ROAI), 3) analysis of the current costs of placing advertisements tied to relevant queries, and 4) content analysis of the web sites of competitors placing advertisements on similar queries. With some human guidance and review, these techniques automatically develop and implement strategies for advertising placement.

Current keyword advertising business models can be improved by automating the advertiser's decision-making, bidding, and placement of advertisements. For example, currently it is to the advertiser's advantage to participate in every auction of relevant keywords. The multiplicity of keyword combinations and the multiplicity of considerations for each keyword combination make advertisement placement clear opportunities for automation support.

An advertiser can use the keyword advertisement management system to partially automate the process of selecting and bidding for keyword combinations, so that with minimal guidance from the advertiser, advertisements can be placed on the most effective keywords. While the keyword advertisement management system is designed for advertisers, to help maximize their ROAI, its use by advertisers also benefits search engine companies using a pay-per-click model by increasing the number keywords that are sponsored, and increasing the click-through rates for advertisements. Consequently, there are several possible business models for exploiting the keyword advertisement management system, including having a search engine company (e.g., Google), an advertising aggregator (e.g., Overture), or a bidding service provider (e.g. BidRank) to offer the keyword advertisement management system to advertisers via server-based or client-based implementations.

These business models provide the keyword advertising management services described above in several different scenarios. In a first scenario, a keyword search engine or advertising aggregator provides keyword advertising management services through a provider-based (i.e., server-based) keyword advertisement management system. In a second scenario, a bidding service provider provides keyword advertising management services through an independent, decentralized (i.e., server-based) keyword advertisement management system. In a third scenario, the keyword search engine, advertising aggregator, bidding service provider, advertiser, or a software developer/distributor, for example, provides an independent, decentralized (i.e., client-based) keyword advertising management system.

In the first scenario, the advertising management function is deployed and provided directly by a pay-per-click (PPC) advertising service provider (e.g., Google, Overture, etc.), as part of the “advertiser website.” One advantage of this scenario is that a single keyword search engine or advertising aggregator makes usage, payments, etc., much simpler to the end-user (i.e., advertiser). This is particularly advantageous to small business owners wishing to advertise. Another advantage is that adoption of this type of keyword advertisement management system is much quicker since it can “appear” as an additional option on the interface that end-users are already using. One disadvantage of this scenario is that the service provider's incentives are not always aligned with incentives of the advertisers. However, any system may have a service provider bias.

In the second scenario, the advertising management function is deployed and provided directly by an independent third party (e.g., bidding service provider) on behalf of advertisers. One advantage of this scenario is that the keyword advertisement management system may be designed to serve the best interests of the advertisers rather than the PPC advertising service provider. One disadvantage of this scenario is that the service is more difficult to adopt because, for example, the system includes a new tool to download, install, register, and learn. The new tool may be more difficult to use. Additionally, there may be less automated historical and current auction data because keyword search engines may not provide “live” auction data to the bidding service providers. Furthermore, keyword search engines or advertising aggregators may attempt to block screen-scraping by the bidding service providers through various known techniques, such as CAPTCHAs. Moreover, the keyword search engines and advertising aggregators may contractually prohibit advertisers from using independent keyword advertisement management tools.

In the third scenario, the independent, decentralized keyword advertisement management system is client-based and permits peer-to-peer communication. The advertising management function is managed directly by advertisers using a downloaded peer-to-peer software tool. One advantage of this scenario is that the keyword advertisement management system is designed to suit an advertiser's best interest. Additionally, this system may be lower in cost because it is delivered as a software tool, rather than provided as a subscription service. Moreover, the keyword search engines and advertising aggregators cannot easily shut down the keyword advertising management system. One disadvantage of this scenario is that installation and use of the system may be more difficult than the other scenarios.

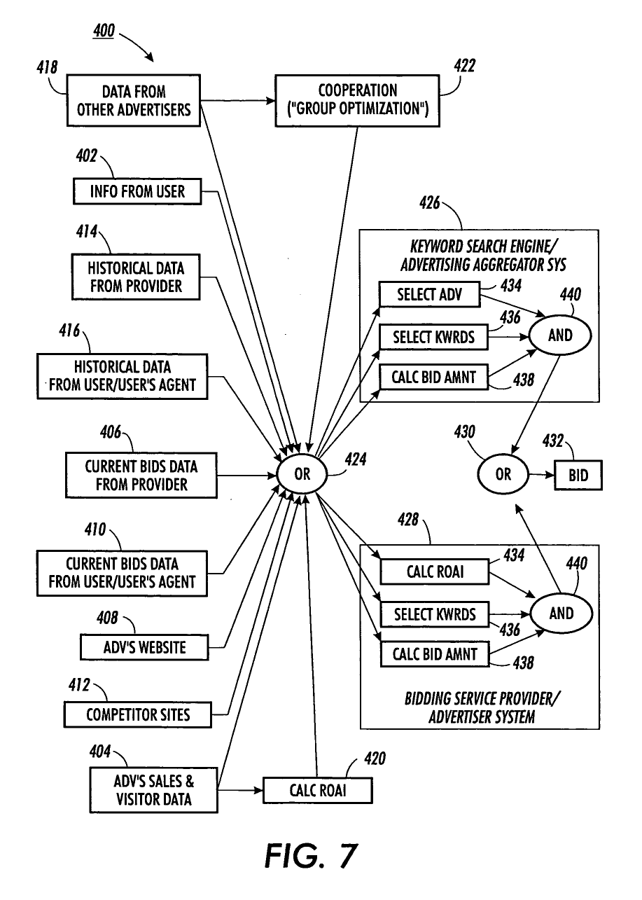

The keyword advertisement management systems in each of these scenarios may utilize input data from various sources to determine an appropriate amount to bid for a particular keyword advertisement position in relation to a search results list associated with a search query. FIG. 7 depicts an exemplary bid optimization process 400 for bidding on placement of keyword advertisements in a search results list. The keyword advertising management system may receive user information from the advertiser 402 via, for example, the input device. In various other embodiments, the system may receive sales and visitor data from the advertiser web site 404, current bid data from the keyword search engine or advertising aggregator 406, advertiser web site data from the content of the advertiser web site (i.e., presumably by “crawling”) 408, current bid data from users 410 via the input device, competitor web site data from the content of a competitor's website (i.e., presumably by “crawling”) 412, historical data about keyword frequency and bids from the keyword search engine or advertising aggregator 414, historical data about keyword frequency and bids from users 416 via the input device, and data from other advertisers 418 via bidding coordination services.

The sales and visitor data may be used to calculate ROAI 420. The data from other advertisers may be used by group optimization logic to provide cooperation 422 between advertisers in the group. This information may be used individually or in any combination as reflected by the first OR module 424. The input information is provided to the keyword advertisement management system by the first OR module 424 whether it implements the scenario described above with respect to the keyword search engine or advertising aggregator 426 or the scenarios described above with respect to the bidding service provider or advertiser 428. The second OR module 430 reflects that any scenario for keyword advertisement management may be implemented to produce the bid 432. As shown, any implementation of the keyword advertisement management system may include algorithms for selecting an advertisement 434, selecting one or more keywords 436, and calculating a bid amount 438. The result of these algorithms are combined as reflected by the AND module 440 to ultimately produce the bid 432. It is understood that in some embodiments, the keyword management system may optionally not include the algorithm for selecting an advertisement 434. Rather, the advertisement may be chosen after a bid 432 is made, and such a selection may be undertaken manually.

The keyword advertisement management systems in each of these scenarios may provide various methods associated with keyword advertising. For example, in one embodiment, the system may provide a method for selecting an advertisement and associating the advertisement with a bid. In various additional embodiment, the system may provide a method for generating and selecting keywords and associating the selected keywords with a bid, determining an amount to bid and associating with the bid with an advertisement and one or more keywords, optimizing bids by selecting less expensive keyword combinations, calculating ROAI based on sales and visitor data from the advertiser web site, and explicitly (or implicitly) cooperating with other advertisers in an advertiser group to optimize bidding on keywords of interest to the members of the group.

A strategy for selecting and bidding on keyword combinations in the keyword advertisement management system can be based on a variety of information sources and analytic techniques, such as content analysis of the advertiser's web site. This may include recommendation-type keyword selection or content-type keyword selection. Selecting and bidding on keyword combination may also be based on analysis of ROAI, competitive analysis, and/or optimization of marketing messages.

A variety of document content analysis techniques, originally developed for information retrieval, can be applied to keyword advertising management. Initially, topic analysis techniques can be applied to the content of a candidate advertisement and its associated web site. The use of such techniques greatly enhance the quality of keywords selected by describing a web site by topics, and then choosing keywords based on these topics. Keyword selection can be viewed as a special instance of query expansion. While there are a number of query expansion selection techniques, these techniques can be classified into two broad general categories: recommendation- or usage-based techniques and content-based techniques. Recommendation-based techniques leverage usage patterns, user relevance feedback, and statistical natural language processing (NLP) to identify new keywords. The usage-based technique makes keyword recommendations based on other users' behavior (i.e., people who have searched on keyword X looked at documents that contained keyword Y). The content-based approach can use NLP to identify keywords that are related to initial set of keywords. In both classes, the notion of keyword is not restricted to just a single token but is expanded to include phrases. The use of phrases has been shown to improve retrieval performance.

Recommendation-type keyword selection uses relevance feedback to identify new keywords. Since explicit user relevance is prohibitively expensive to collect, search engine query logs in the form of query word or words and selected URLs are used to provide pseudo-relevance. Recommendation-type Keyword selection can be generally classified into two categories: content-independent and content-sensitive. In content-independent recommendation-type keyword selection, the query terms and URLs are clustered using a number of techniques. An example of content-independent recommendation-type keyword selection is described in Agglomerative Clustering of a Search Engine Query Log, Doug Beeferman and Adam Berger, KDD 2000, pages 407-416, incorporated herein by reference. One possible enhancement to this model is to use a generative model based on latent variables. This type of model is described in Probabilistic Models for Unified Collaborative and Content-Based Recommendation in Sparse-Data Environments, Alexandrin Popescul, Lyle H. Ungar, David M. Pennock, and Steve Lawrence, Proceedings of the 17th Conference on Uncertainty in Artificial Intelligence (UAI-2001), incorporated herein by reference.

The second class of recommendation-based keyword selection uses the actual content of the pages to develop a probabilistic model of word pair association. This approach is presented in Probabilistic Query Expansion Using Query Logs, Hang Cui, Ji-Rong Wen, Jian-Yun Nie, and Wei-Ying Ma, WWW2002, May 7-11, 2002, Honolulu, Hi., USA, incorporated herein by reference. This model builds a naïve Bayes probabilistic model using all pairs of co-occurring search query terms and noun phrases in a target document. Again, this model can be expanded upon using the concept of latent variables or aspect models.

The other class of keyword selection algorithms—content-based keyword—does not build on user feedback. There are two general classes of content-based keyword selection. The fist class is the based on a global analysis of a representative corpus. Commonly co-occurring phrases indicate a strong similarity and are therefore good candidates for keyword selection. The second class is based on an analysis of term frequencies in a relevant document set. Since a relevant document set is hard to identify for all topics, pseudo-relevance feedback is used (i.e., namely all the documents that are retrieved by a search engine when queried with the initial keywords). A statistical analysis test is performed on the relevant set to identify which phrases differ significantly from the general corpus. This approach is presented in Accurate Methods for the Statistics of Surprise and Coincidence, Ted Dunning, Computational Linguistics, Jan. 7, 1993, incorporated herein by reference.

Xu and Croft used global techniques to identify a set of candidate expansion terms and then used local analysis to refine that set in Query Expansion Using Local and Global Document Analysis, Jinxi Xu and W. Bruce Croft, Proceedings of the 19th Annual International ACM SIGIR Conference on Research and Development in Information Retrieval, 1996, pages 4-11, incorporated herein by reference. An extension to the work presented by Xu and Croft is to use our topic analysis techniques (i.e., Probabilistic Latent Semantic Analysis (PLSA)) to perform global analysis.

The above approaches are not mutually exclusive and can be combined together in various arrangements. For example, a recommendation-type system based on an aspect model that ranks keywords based on the probability of generating the keyword given the query can be combined with a global content-based system that ranks documents based on their smoothed co-occurrence with query terms and a local content analysis system that ranks keywords based on their co-occurrence statistics. A rank aggregation algorithm can then be used to aggregate the three ranked lists into an optimal list. This approach is described in AuGEAS (AUthoritativeness Grading, Estimation, and Sorting), Ayman Farahat, Geoff Nunberg, and Francine Chen, Proceedings of the Eleventh International Conference on Information and Knowledge Management, CIKM '02, Nov. 4-9, 2002, pages 194-202, incorporated herein by reference.

This lower-dimensional topic representation has several advantages. First, while many keywords can be chosen directly from their frequency (i.e., term frequency inverse document frequency (TFIDF)) in the advertiser's web site, choosing additional keywords based on topic selects appropriate keywords even when they are under-represented or absent from the web site. Second, when a topic representation indicates that a web site covers several topics, the keyword selection can be grouped according to topic, allowing for human guidance to select the advertising emphasis by topic, and tracking of yield by topic. Third, a topic representation of an advertiser's site, when compared with similar representations of competitor's sites, assists in determining bidding strategies. Finally, when keywords are being considered for advertisement placement, the topic representation of an advertiser's site can be compared with a topic representation of the regular results of the keyword query, as a measure of the distance of the advertisement site from the query and a prediction of the click-through rate if the advertisement were placed on the keywords being considered.

Topic analysis can be accomplished different several ways. For example, a probabilistic latent semantic analysis (PLSA) can be used to represent an advertisers web site (denoted “d” for document) as a distribution across several latent indices z(1), z(2), z(3). That is, the vector P(z(1)|d), P(z(2)|d) . . . P(z(n)|d), provides a lower dimensional representation of the topics of the web site, and the other portion of the PLSA, the probability of words given latent indices, P(w(i)|z0)), can be used for keyword selection. Alternatively, the PLSA estimate of the probability of the words given the document can be used for keyword selection: P(w(i)|d)=ΣP(w(i)|z) P(z|d). In either case, the selection is based on identifying the highest probability terms. Note that terms not in the document, but which are very relevant to the topic, may be selected. Another possibility is to use any clustering method, such as k-means or fuzzy clustering based on EM, or a combination of clustering and classification, such as initializing clusters using k-means and then refining the clusters or adding new documents using k-nearest-neighbors, may be performed to group web sites, and then compute a soft assignment of the advertiser's web site to the clusters. This assignment provides a lower dimensional representation of the topic of the web site and the contents of nearby clusters may be used for keyword selection. These methods can also be applied to sequences of terms, such as phrases. The phrases can be n-grams, noun phrases, or other linguistically motivated phrases. To compare the key phrases against single terms, normalization of the score by the key phrase length is needed.

Although less detailed than a full topic analysis, there are similarity measures such as the Cosine distance and KL distance that can be used to judge the distance between documents. These techniques provide alternative technology for several of the applications mentioned above, where it was useful to judge the distance between an advertiser's web site and a competitor's web site, or to judge the distance between an advertiser's web site and query results for a particular keyword combination.

Finally, we note that whenever the automated system decides to bid on alterative keywords, it is desirable to present advertisements which incorporate the keywords. While it is possible for the advertiser to write a generic advertisement such as “Searching for X, then you might be interested in . . . ,” and then let the automated tool replace X with alternative keywords. It is also possible for the system to rewrite advertisements that the advertiser has already written, making use of content analysis of the topic of the keywords, and natural language processing of the earlier advertisements.

Undoubtedly, the principal consideration in advertising investment is not simply how often a user clicks through an advertisement, but rather, the total return of a click-through (which may be based on a particular keyword and/or a particular advertisement, or an average for the web site regardless of keyword and advertisement combinations). In the previous example, when a design automation software company, bidding on the “deck plans” combination of keywords, knows that 1 of 100 click-through visits results in one on-line sale of their product having a profit of $40, this company knows that the benefit of each click-through is worth exactly $0.40. Thus, the company can create a bidding strategy based on this information. The auction provides a market mechanism to determine which companies' advertisements are displayed (that is, the most profitable advertisements, per click-through, are displayed). A company with an accurate understanding of its ROAI is better able to determine appropriate bidding for keywords.

Presently, only a few online businesses (e.g., FindMyJeweler.com and potentially advanced e-tailers, e.g., Amazon.com) are well enough integrated to track their returns at a level of granularity necessary to know their return on a click-through. The current trend, represented by the efforts to develop standards for Web services, is to significantly increase the integration of business information, and thereby increase an advertiser's accuracy in understanding their return on a click-through, including down to the level of granularity of the keyword and advertisement. To take advantage of such data, one embodiment of this application includes technology in the area of utilizing return on click-through data to partially or fully automate bidding and keyword selection. Even before a company is able to do full end-to-end tracking of ROAI, it is possible to estimate eventual returns from web log data (i.e., how long customers visited, what pages they visited, customers registering, or requesting downloads) and use returns estimated from this data as a proxy for more accurate ROAI.

When ROAI is known or can be estimated, a party will still need to consider what is the correct bidding strategy and how can the process be more fully automated. A simple approach is to bid up to profit-per-click-through, hopefully winning the auction for much less. Notice, however, that these high levels of bidding gradually shift profit to the search engine (or advertising aggregator). A more sophisticated analysis incorporates alternative avenues for marketing, either: i) supplied externally by a human ordiscovered by the content analysis described above, ii) by strategic marketing objectives by the corporation (i.e., is the goal to maximize profit or to maximize revenue/market share?) or iii) by the competitive analysis described below. In this way the bidding for particular keywords is restrained by the profitability of alternatives, or potentially “unleashed” by a strategic corporate mandate to maximize market share.

One problem with estimating ROAI is obtaining sufficient data to draw statistically meaningful conclusions. This problem is more acute with automation, where some keyword combinations may be tried experimentally, and it may be desirable to track ROAI for a variety of keyword combinations and advertisements. The rate of data obtained for any single keyword combination is slow, but the content analysis of the preceding section can be used to create meaningful aggregations of the data, so, e.g., one may know more rapidly and accurately ROAI by topic, or ROAI by distance of query results from the advertiser's web site.

Finally, at a different level, the provider of the keyword advertisement management system can refine the procedure the system uses for keyword selection (described above) by using ROAI results (presumably supplied by customers) to train the system. That is, with sufficient data, various criteria for keyword selection, such as TFIDF weighted scoring of a term, PLSA probability of a term, shallow parsing features, etc. can be weighted according to their predictive value.

Another source of information that can be analyzed is the bidding and placement of a competitor's advertising. By applying content analysis to competitors in the auctions, it is possible to characterize the nature of the competition. When competitors are similar, there are opportunities for learning (e.g., discovery of more keyword possibilities) and it is more likely that ROAI will be similar, so bidding wars are not constructive. Whereas when competitors are different (e.g., the design automation software company bidding on “deck plans” against a wood sealer company), content analysis can provide a way for one of the competitors to find disjoint topics and disjoint keywords that are less expensive for advertisement placement.

Ultimately, winners and losers in a particular category are determined by each player's ability to convert visitors into customers. Conversion efficiency is primarily driven by the “4 P's of marketing”—product, pricing, promotion, and positioning. By tracking the performance of certain keywords and advertising messages, positioning can be refined dynamically by optimizing marketing messages (on the web site or on other promotional material) to optimize the corporation's strategic objectives.

While any one of the data gathering and analysis techniques described above is useful to advertisers, a scenario of how a keyword advertisement management system might incorporate several or all of the above techniques:

An advertiser begins by supplying an advertisement (and the web site associated with the advertisement) to the keyword advertisement management system. The system processes the advertisement (and site) to extract keywords, analyzes the site to determine topic(s) and extracts keywords (that may not be represented on the site) based on topic(s). The keywords are further expanded by finding competitors, with similar web sites, bidding on the same keywords, and then adding additional keywords where those competitors are bidding. This creates an initial universe of possible keywords.

Keyword combinations (e.g., pairs and triples of keywords that are typically supplied to the search engines) are developed by using topic analysis to join related keywords and by trying queries of keyword combinations and then measuring the proximity of the query results to the advertiser's original web site. The candidate keyword combinations are presented to the advertiser, organized by topic and distance from the advertiser's web site. Human guidance may be solicited to select such things as: keyword combinations, topics, proximity thresholds, or levels of bidding.

Using a preliminary model of ROAI based on proximity of query results, the keyword advertisement management system may enter the most promising auctions and, for experimental purposes, may enter some less promising auctions. Real ROAI is tracked (e.g., based on keyword combinations) and aggregated (e.g., based on topic and proximity) so that a more accurate model of ROAI can be developed. Eventually the keyword advertisement management system may optimize ROAI by dropping out of the less productive auctions.

As competitors respond in the auctions, the keyword advertisement management system uses ROAI data to determine how high to bid, and, if necessary, topic analysis (of the competitors web sites) to find less competitive and more productive keyword combinations. Altogether, such a system lets keyword advertisers simultaneously enter and track the results of multiple keyword auctions, more productively target their advertising, and better understand the nature of keyword advertising side of their business.

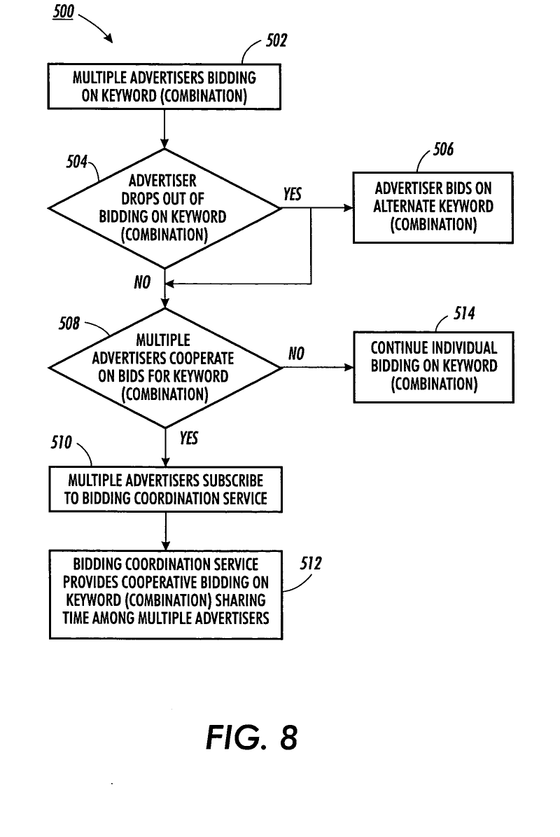

With reference to FIG. 8, an exemplary bidding coordination process for cooperative bidding among multiple advertisers 500 reflects at least a portion of the group optimization logic for a system such as described in connection with FIGS. 4 and 5. The process 500 begins at step 502 where multiple advertisers are bidding on keyword advertisement positions associated with a keyword or keyword combination. At step 504, the process determines whether one or more of the multiple advertisers should drop out of bidding on the keyword or keyword combination. For each advertiser that drops out of the bidding, the process may suggest that the dropping advertiser continue to bid on an alternate keyword or keyword combination (step 506).

If the process determines that multiple advertisers should continue bidding on the keyword or keyword combination, at step 508, the process determines whether or not the multiple advertisers should cooperate on bids for the keyword or keyword combination. If the process determines that multiple advertisers should cooperate, then the process may suggest that each of the multiple advertisers subscribe to a bidding coordination service (if the advertiser is not currently subscribed) (step 510). When the multiple advertisers are subscribed, the bidding coordination service provides cooperative bidding on the keyword or keyword combination by sharing time among the multiple advertisers at a reduced bid from that which would result from individual bidding without cooperation (step 512). The cooperative bidding may take the form of a joint bid representing the multiple advertisers or individual bids from each advertiser reflecting the cooperating bidding strategy. At step 508, if the process determines there is not an advantage for the multiple bidders to cooperate on bids, the bidding on the keyword or keyword combination continues with individual bidding by each of the multiple bidders without cooperating on the individual bids.

For the cooperative bidding strategy described above, multiple individual advertisers subscribe to the bidding coordination service and provide the service with information about their utility for various keyword combinations. This utility information may include: which keywords combinations are effective for advertising their products, expected returns for particular keywords. (CLIP), expected click-through rate, and preferences on timing and amount of advertisement presentation.

Typically, the bidding coordination service works best when it is devising a joint strategy for almost all of the bidders for a particular keyword combination. To reach this state, new subscribers seeking coordination for particular keyword combinations may provoke the coordination service to attempt to recruit other advertisers already observed to be bidding on those keyword combinations.

While it may be nice if the bidding coordination service could trust the utility information supplied by the advertisers (and conversely the advertisers could trust the coordination service with their utility information), it is difficult to specify the behavior of the bidding coordination service to achieve is level of trust. In economic terms, such a system would be an “incentive compatible” mechanism. Incentive compatibility is difficult to achieve in combination with other desirable properties for the mechanism. Therefore, one task of the bidding coordination service may include testing the utility of information supplied by the subscribers. There are several ways to test the accuracy of the utility information. For example, to test keywords, the content of the subscriber's web site can be analyzed using information retrieval technology to judge if the keywords are related to the content or topic(s) of the web site. With implicit or explicit permission, the utility information can be relayed to other subscribers in similar businesses to solicit a manual endorsement of the accuracy of the utility information. (Here broader social trust mechanisms will play a role in supporting honest collaboration.) The coordination service can test the expected return information by occasionally arranging for advertisers to pay near their expected returns. The coordination service, when suggesting a joint strategy to several subscribers, can also describe the assumptions in their collected utility information that were used to derive the joint strategy. At this point, participants suspecting a lack of honesty by others could challenge some of the assumptions and force the bidding coordination service to use the other tests described above, or to use a third party human arbiter to judge the accuracy of the utility information.

With accurate information, the bidding coordination service can devise joint strategies, such as asking participants with lower expected returns to move to alternative keyword combinations and/or devising rotation patterns that allow several bidders to take turns winning an auction for a particular keyword combination. More elaborate cooperation strategies can be devised by applying the techniques of cooperative game theory (e.g., Shapley value computations) to the utility information, and devising joint strategies where some advertisers win the bidding consistently, but side payments are used to compensate the other participants for their cooperation. However, these more complex strategies may be harder for the participants to understand and trust, so even if they are theoretically better from the standpoint of global utility, they may not work as well at expected due to lack of trust by the participants.

Once the coordination service devises a joint strategy, it can be implemented several possible ways. For example, each time an advertiser uses the web interface (provided by advertising services) to adjust bids in keyword auctions, a plug-in in the advertiser's browser can contact the bidding coordination service and pop-up an additional window with timely bidding advice for the auctions involved. Additionally, subscribers can receive e-mail updates from the bidding coordination service asking them to make changes in their bidding in accordance with an agree-upon joint strategy or alerting the subscriber to changes in the auction and suggesting a new joint strategy. Further, the bidding coordination service may permit some subscribers to authorize the bidding coordination service to directly modify the subscriber's bids.

In summary, several aspects of the keyword advertisement management system, which has now been described, include: 1) determining a bid to elicit a change in the bidding strategy of other advertisers, 2) tracking ROAI tied to keywords and using this data to determine bidding strategy, 3) use of content analysis techniques to suggest alternative keywords, 4) use of content analysis to structure ROAI data gathering, to increase statistical significance, and build models of ROAI that generalize to new keywords (e.g., modeling ROAI based on topic or distance from an advertiser's web site), 5) use of content analysis to understand the strategic relationship between bidders and to automate the bidding accordingly, 6) use of content analysis to organize the way that ROAI data and bidding strategies are presented to the human user to facilitate better understanding of the advertising side of the business and to facilitate some manual guidance of the otherwise automatic tool, 7) use of content analysis and/or natural language processing to write advertisements automatically to test certain keywords (and also to test new advertisements), 8) use of Web Services or other technologies that would yield the same result that interconnect an advertiser's sales results, a search engine's bidding tool, an ROAI optimization engine (which outputs bids/keyword combinations), a keyword generation tool, and an advertisement generation tool (these components may be implemented separately or “bundled” together in various combinations; of course, some components may be omitted or implemented manually), 9) for advertisers that advertise on more than one PPC web site at a time, the keyword advertisement management system can handle multiple PPC web sites and optimize ROAI for the advertiser, 10) the keyword advertisement management system may handle more than just PPC web sites, for example, traditional advertising on content web sites and associated with e-mail, 11) the keyword searching environment includes processes that permit coordination of bids from multiple advertisers in conjunction with certain techniques for group optimization, and 12) the keyword searching environment includes processes that induces full cooperation between providers and advertisers to maximize profitability and a mechanism to divide profits in an automatic manner among the providers and advertisers.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of coordinating one or more bids for one or more groups of advertisers for placement of at least one advertisement in association with a first search results list, wherein the first search results list is generated in response to a first search query, the method including the steps:
a) collecting information from at least two advertisers in the advertiser group; and
b) devising a joint strategy for the advertiser group for bidding in the keyword auction.

2. The method as set forth in claim 1 wherein the collected information is associated with an initial bid for placement of an advertisement associated with an initial one or more keywords, wherein the initial one or more keywords are associated with the first search query and the initial bid is associated with a keyword auction associated with placement of the at least one advertisement in the first search results list.

3. The method as set forth in claim 1 wherein the joint strategy includes a recommendation to at least one advertiser in the advertiser group as to whether the at least one advertiser should select an alternate one or more keywords on which to bid instead of the initial one or more keywords, wherein the alternate one or more keywords are associated with a second search query and a corresponding second search results list.

4. The method as set forth in claim 1 wherein the joint strategy includes a recommendation to one or more advertisers in the advertiser group that includes a first revised bid associated with a first time period and a second revised bid associated with a second time period.

5. The method as set forth in claim 1 wherein the joint strategy includes a first revised bid associated with a first time period and a second revised bid associated with a second time period for one or more advertisers in the advertiser group, wherein the first and second revised bids are provided to the keyword auction.

6. The method as set forth in claim 1 wherein the joint strategy includes a cooperative bid for one or more advertisers in the advertiser group, wherein the cooperative bid is provided to the keyword auction.

7. The method as set forth in claim 1, further including:
c) recruiting one or more additional advertisers to join the advertiser group.

8. The method as set forth in claim 1, further including:
c) testing the collected information received from at least one of the advertisers in the advertiser group for at least one of accuracy and utility.

9. The method as set forth in claim 1 wherein a plurality of bids is coordinated for placement of a corresponding plurality of advertisements in association with the first search results list for a corresponding plurality of advertisers in the advertiser group, wherein the joint strategy includes coordinating compression of the plurality of bids to reduce related advertising costs for at least one of the plurality of advertisers.

10. The method as set forth in claim 1, further including:
c) coordinating exchange of rewards between advertisers in the advertiser group for cooperating.

11. The method as set forth in claim 10, further including:
d) calculating at least one of a type of the rewards and an amount of the rewards.

12. The method as set forth in claim 10, further including:
d) recommending at least one of a type of the rewards and an amount of the rewards.

13. The method as set forth in claim 1, further including:
c) exchanging information between advertisers in the advertiser group.

14. The method as set forth in claim 13 wherein the exchanged information is for at least one of negotiation and relationship building.

15. The method as set forth in claim 13 wherein the exchanged information is exchanged via at least one of a shared messaging area, a private messaging area, a collaborative messaging environment, a chat room, a mailing list, and a message forum.

16. The method as set forth in claim 1, further including:
c) adjusting the joint strategy when one or more advertiser in the advertiser group does not implement the devised joint strategy.

17. The method as set forth in claim 16 wherein at least one of a recommended bid and a recommended time associated with the bid is adjusted for one or more advertisers in the advertiser group in the adjusted joint strategy.

18. A method of generating a bid for a first advertiser for placement of a first advertisement in association with a search results list, wherein the search results list is generated in response to a search query, the method including the steps:
a) selecting at least one keyword, wherein the search query is associated with the at least one keyword;
b) associating the at least one keyword with the bid;
c) determining a first amount of the bid for placement of the first advertisement in association with the search results list generated in response to the search query associated with the at least one keyword; and
d) exchanging information with a second advertiser bidding on placement of a second advertisement in association with the search results list generated in response to the search query associated with the at least one keyword, wherein the information exchanged at least includes the first amount.

19. The method as set forth in claim 18, further including:
e) adjusting the first amount to a second amount for a first time period, wherein the first and second advertisers agree upon the second amount and the first time period.

20. The method as set forth in claim 19, further including:
f) adjusting the first amount to a third amount for a second time period, wherein the first and second advertisers agree upon the third amount and the second time period.

21. The method as set forth in claim 20, further including:
g) adjusting the first amount to a fourth amount for a third time period when the second advertiser does not comply with an agreement associated with at least one of the first and second time periods.

22. The method as set forth in claim 21 wherein at least one of the fourth amount in relation to the second and third amount and the third time period in relation to the first and second time period is adjusted to compensate for the second advertiser not complying with the agreement.

23. The method as set forth in claim 18, further including:
e) selecting an alternate at least one keyword and repeating steps a)-d).

24. The method as set forth in claim 18 wherein the information exchanged with the second advertiser is considered in at least one of steps a)-c).

25. The method as set forth in claim 18 wherein the search results list is generated by a server-based keyword search engine and the bid generating method is client-based in relation to the first advertiser and the keyword search engine, wherein the bid generation is at least partially automated.

26. The method as set forth in claim 18 wherein the search results list is generated by a server-based keyword search engine and the bid generating method is server-based in relation to the first advertiser and the keyword search engine, wherein the bid generation is at least partially automated.

27. The method as set forth in claim 26 wherein the keyword search engine is associated with a first server and the bid generating method is associated with a second server.

28. The method as set forth in claim 18, further including:
d) selecting the first advertisement to be associated with the bid, wherein the first advertisement is selected at least in part by matching content of the first advertisement to the at least one keyword.

29. The method as set forth in claim 18 wherein the at least one keyword associated with the first advertisement is selected at least in part by analyzing content of the first advertisement.

30. The method as set forth in claim 18 wherein the at least one keyword is selected at least in part by matching one or more of the at least one keyword to content of the first advertisement.

31. The method as set forth in claim 18 wherein the information is exchanged with the second advertiser via a centralized bidding coordination service.

32. The method as set forth in claim 18 wherein the information is exchanged with the second advertiser via first and second group optimization logic processes corresponding to the first and second advertisers.

33. The method as set forth in claim 18 wherein the first and second advertisers are members of a cooperative bidding group.

34. The method as set forth in claim 33 wherein the cooperative bidding group includes one or more additional advertisers bidding on placement of corresponding advertisements in association with the search results list generated in response to the search query associated with the at least one keyword, wherein the information exchanged is exchanged among each of the advertisers in the cooperative bidding group.

35. The method as set forth in claim 33, further including:
e) recruiting one or more additional advertisers to join the cooperative bidding group.

36. The method as set forth in claim 18, further including:
e) testing the information exchanged between the first and second advertisers for at least one of accuracy and utility.

37. The method as set forth in claim 18 wherein the exchanged information is for at least one of negotiation and relationship building.

38. The method as set forth in claim 18 wherein the exchanged information is exchanged via at least one of a shared messaging area, a private messaging area, a collaborative messaging environment, a chat room, a mailing list, and a message forum.

39. An apparatus for generating a bid for a first advertiser for placement of a first advertisement in association with a search results list, wherein the search results list is generated in response to a search query, the apparatus including:
an advertisement selection system for selecting the first advertisement to be associated with the bid;
a keyword selection system in communication with the advertisement selection system for selecting a plurality of keywords associated with the advertisement;
a keyword/bid association system in communication with at least one of the advertisement selection system and keyword selection system for associating one or more of the plurality of keywords with the bid, wherein the search query is associated with the one or more keywords;
a bid determination system in communication with at least one of the advertisement selection system, keyword selection system, and keyword/bid association system for determining a first amount of the bid for placement of the selected advertisement in association with the search results list generated in response to the search query associated with the one or more keywords; and
a group optimization logic system in communication with the bid determination system for exchanging information with a second advertiser bidding on placement of a second advertisement in association with the search results list generated in response to the search query associated with the at least one keyword, wherein the information exchanged at least includes the first amount.

40. The apparatus as set forth in claim 39 wherein the bid determination system uses the information exchanged with the second advertiser to adjust the first amount to a second amount for a first time period, wherein the first and second advertisers agree on the second amount and the first time period.

41. The apparatus as set forth in claim 40 wherein the bid determination system uses the information exchanged with the second advertiser to adjust the first amount to a third amount for a second time period, wherein the first and second advertisers agree on the third amount and the second time period.

42. The apparatus as set forth in claim 39 wherein the keyword selection system uses the information exchanged with the second advertiser to select an alternate at least one keyword and the keyword/bid association system and bid determination system operate using the alternate at least one keyword.

43. The apparatus as set forth in claim 39 wherein the information exchanged with the second advertiser is used by at least one of the advertisement selection system, keyword selection system, keyword/bid association system, and bid determination system.

44. The apparatus as set forth in claim 39 wherein the information is exchanged with the second advertiser via a centralized bidding coordination service.

45. The apparatus as set forth in claim 39 wherein the first and second advertisers are members of a cooperative bidding group.

46. The apparatus as set forth in claim 45 wherein at least one of the bid determination system and group optimization logic system recruits one or more additional advertisers to join the cooperative bidding group.

47. The apparatus as set forth in claim 39 wherein at least one of the bid determination system and group optimization logic system tests the information exchanged between the first and second advertisers for at least one of accuracy and utility.

48. A method of coordinating bids from a first advertiser and a second advertiser for placement of at least one advertisement in association with a first search results list, wherein the first search results list is generated in response to a first search query, the method including the steps:
a) receiving at least one keyword selected by both the first and second advertisers, wherein the first search query is associated with the at least one keyword;
b) receiving information from each of the first and second advertisers associated with an initial bid for placement of corresponding first and second advertisements in association with the first search results list in response to the first search query;
c) determining whether the first and second advertiser should cooperate on bids for placement of the first and second advertisements in association with the first search results list in response to the first search query associated with the at least one keyword; and
d) if the first and second advertisers should cooperate on bids, determining a first amount for the first advertiser to bid during a first time period and a second amount for the second advertiser to bid during the first time period for placement of the first and second advertisements in association with the first search results list in response to the first search query, wherein the first and second advertisers agree upon the first and second amounts and the first time period, otherwise, continuing individual bidding by the first and second advertisers for placement of the first and second advertisements in association with the first search results list in response to the first search query.

49. The method as set forth in claim 48, further including:
e) if the first and second advertisers should cooperate on bids, determining a third amount for the first advertiser to bid during a second time period and a fourth amount for the second advertiser to bid during the second time period for placement of the first and second advertisements in association with the first search results list in response to the first search query, wherein the first and second advertisers agree upon the third and fourth amounts and the second time period.

50. The method as set forth in claim 48, further including:
e) determining whether the first or second advertiser should bid on an alternate at least one keyword associated with a second search query and a corresponding second search results list;
f) if the first or second advertiser should bid on the alternate at least one keyword, recommending that the corresponding first or second advertiser bid on the alternate at least one keyword while the remaining advertiser continues to bid on the at least one keyword associated with the first search query and the corresponding first search results list.

51. The method as set forth in claim 48 wherein the bid coordinating method steps are performed by a centralized bidding coordination service.

52. The method as set forth in claim 48 wherein the bid coordinating method steps are performed independently by first and second group optimization logic processes corresponding to the first and second advertisers.

53. The method as set forth in claim 48 wherein the first and second advertisers are members of a cooperative bidding group.

54. The method as set forth in claim 53 wherein the cooperative bidding group includes one or more additional advertisers bidding on placement of corresponding advertisements in association with the first search results list generated in response to the first search query associated with the at least one keyword, wherein steps a)-d) are performed in conjunction with each of the advertisers in the cooperative bidding group.

55. The method as set forth in claim 53, further including:
e) recruiting one or more additional advertisers to join the cooperative bidding group.

56. The method as set forth in claim 48, further including:
e) testing the information received from at least one of the first and second advertisers for at least one of accuracy and utility.

57. A computer program product for use with an apparatus for coordinating bids from a first advertiser and a second advertiser for placement of at least one advertisement in association with a first search results list, wherein the first search results list is generated in response to a first search query, the computer program product including:
a computer usable medium having computer readable program code embodied in the medium for causing:
i) receiving at least one keyword selected by both the first and second advertisers, wherein the first search query is associated with the at least one keyword;
ii) receiving a first bid amount from each of the first and second advertisers for placement of corresponding first and second advertisements in association with the first search results list in response to the first search query;
iii) determining whether the first and second advertiser should cooperate on bids for placement of the first and second advertisements in association with the first search results list in response to the first search query associated with the at least one keyword; and
iv) if the first and second advertisers should cooperate on bids, determining a first amount for the first advertiser to bid during a first time period and a second amount for the second advertiser to bid during the first time period for placement of the first and second advertisements in association with the first search results list in response to the first search query, wherein the first and second advertisers agree upon the first and second amounts and the first time period, otherwise, continuing individual bidding by the first and second advertisers for placement of the first and second advertisements in association with the first search results list in response to the first search query.
